(19) United States
(12) Patent Application Publication
(10) Pub. No.: US 2026/0209394 A1
(43) Pub. Date: Jul. 23, 2026

(54) ESTERIFICATION OF ALPHA-GLUCAN COMPRISING ALPHA-1,6 GLYCOSIDIC LINKAGES

(71) Applicant: NUTRITION & BIOSCIENCES USA 4, INC., WILMINGTON, DE (US)

(72) Inventors: OLIVER PETERMANN, BOMLITZ (DE); HELEN S. M. LU, WALLINGFORD, PA (US); JUERGEN ENGELHARDT, BOMLITZ (DE); ZHENGZHENG HUANG, HOCKESSIN, DE (US); DOUGLAS J. ADELMAN, WILMINGTON, DE (US)

(21) Appl. No.: 19/137,392

(22) PCT Filed: Dec. 14, 2023
(86) PCT No.: PCT/US2023/083990

§ 371 Date: Jun. 10, 2025

Related U.S. Application Data
(60) Provisional application No. 63/387,712, filed on Dec. 16, 2022.
(60) Provisional application No. 63/387,707, filed on Dec. 16, 2022.

(51) Int. Cl. C08B 37/02

(52) U.S. Cl. CPC C08B 37/0021

(57) ABSTRACT

Methods are disclosed herein for producing ester derivatives of alpha-glucan comprising alpha-1,6 linkages. Such methods can comprise esterifying an alpha-glucan in an esterification reaction composition comprising a liquid reaction medium that contains water and/or organic solvent(s), for example. Esterification reactions can proceed in the form of slurries in some aspects. Further disclosed are alpha-glucan ester compositions produced by the disclosed processes, as well as various applications of using these compositions.

This application claims the benefit of U.S. Provisional Appl. Nos. 63/387,707 (filed Dec. 16, 2022) and 63/387,712 (filed Dec. 16, 2022), which are each incorporated herein by reference in their entirety.

### FIELD

The present disclosure is in the field of polysaccharide derivatives and derivatization processes. For example, the disclosure pertains to processes for esterification of alpha-1,6-glucan, and products comprising alpha-1,6-glucan derivative compositions prepared by such processes.

### BACKGROUND

Driven by a desire to find new structural polysaccharides using enzymatic syntheses or genetic engineering of microorganisms, researchers have discovered oligosaccharides and polysaccharides that are biodegradable and that can be made economically from renewably-sourced feedstocks. Further work has shown that such polysaccharides can be chemically modified (derivatized) to have additional utilities in areas such as personal care, household care, industrial care, pharmaceuticals and food. For example, ethers and esters of alpha-glucan comprising alpha-1,3 glycosidic linkages have been disclosed to have various applications (e.g., U.S. Patent Appl. Publ. Nos. 2016/0304629, 2016/0311935, 2017/0204232, 2014/0187767, 2020/0308371). Various derivatives of alpha-glucan comprising alpha-1,6 glycosidic linkages, and applications for use thereof, have also been disclosed (e.g., U.S. Patent Appl. Publ. Nos. 2018/0312781, 2018/0237816, 2018/0282385). Hydrophobicallly modified alpha-glucans find applications as viscosity modifiers, emulsifiers, and film formers in liquid formulations such as laundry, fabric care, cleaning, and personal care compositions.

Despite these advances, there remains a need for glucan derivatization processes that provide better yields and/or other efficiencies. New processes for esterifying alpha-1,6-glucan (dextran) are disclosed herein, for example, to help address this need.

### SUMMARY

In one embodiment, the present disclosure concerns a method/process of producing an ester derivative of an alpha-glucan (alpha-glucan ester derivative). Such a method/process of producing an alpha-glucan ester derivative can comprise:
(a) contacting an alpha-glucan in a reaction composition with at least one esterification agent comprising an organic group, wherein the reaction composition comprises a solvent (liquid reaction medium) that comprises (i) water and/or (ii) organic solvent, wherein the solvent has a pH of at least about 9.0, wherein at least about 50% of the glycosidic linkages of the alpha-glucan are alpha-1,6 linkages, wherein at least one organic group is esterified to the alpha-glucan thereby producing an alpha-glucan ester derivative, wherein the alpha-glucan ester derivative has a degree of substitution (DoS) up to about 3.0 with the organic group, and
(b) optionally isolating the alpha-glucan ester derivative from at least a portion of the solvent.

In another embodiment, the present disclosure concerns a composition/product comprising an alpha-glucan ester derivative as produced by a method/process as presently disclosed.

### DETAILED DESCRIPTION

The disclosures of all cited patent and non-patent literature are incorporated herein by reference in their entirety.

Unless otherwise disclosed, the terms “a” and “an” as used herein are intended to encompass one or more (i.e., at least one) of a referenced feature.

Where present, all ranges are inclusive and combinable, except as otherwise noted. For example, when a range of “1 to 5” (i.e., 1-5) is recited, the recited range should be construed as including ranges “1 to 4”, “1 to 3”, “1-2”, “1-2 & 4-5”, “1-3 & 5”, and the like. The numerical values of the various ranges in the present disclosure, unless expressly indicated otherwise, are stated as approximations as though the minimum and maximum values within the stated ranges were both proceeded by the word “about”. In this manner, slight variations above and below the stated ranges can typically be used to achieve substantially the same results as values within the ranges. Also, the disclosure of these ranges is intended as a continuous range including each and every value between the minimum and maximum values.

It is intended that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

It is to be appreciated that certain features of the present disclosure, which are, for clarity, described above and below in the context of aspects/embodiments, may also be provided in combination in a single element. Conversely, various features of the disclosure that are, for brevity, described in the context of a single aspect/embodiment, can also be provided separately or in any sub-combination.

The term “polysaccharide” (or “glycan”) means a polymeric carbohydrate molecule composed of long chains of monosaccharide units bound together by glycosidic linkages and on hydrolysis gives the polysaccharide's constituent monosaccharides and/or oligosaccharides. A polysaccharide herein can be linear or branched, and/or can be a homopolysaccharide (comprised of only one type of constituent monosaccharide) or heteropolysaccharide (comprised of two or more different constituent monosaccharides). Examples of polysaccharides herein include glucan (polyglucose).

A “glucan” herein is a type of polysaccharide that is a polymer of glucose (polyglucose). A glucan can be comprised of, for example, about, or at least about, 90%, 91%, 92%, 93%, 94%, 95%, 96%, 97%, 98%, 99%, or 100% by weight glucose monomeric units. Examples of glucans herein are alpha-glucan and beta-glucan.

The terms “alpha-glucan”, “alpha-glucan polymer” and the like are used interchangeably herein. An alpha-glucan is a polymer comprising glucose monomeric units linked together by alpha-glycosidic linkages. In typical aspects, the glycosidic linkages of an alpha-glucan herein are about, or at least about, 80%, 81%, 82%, 83%, 84%, 85%, 86%, 87%, 88%, 89%, 90%, 91%, 92%, 93%, 94%, 95%, 96%, 97%, 98%, 99%, or 100% alpha-glycosidic linkages. An example of an alpha-glucan polymer herein is alpha-1,6-glucan.

The terms “alpha-1,6-glucan”, “poly alpha-1,6-glucan”, “alpha-1,6-glucan polymer”, “dextran”, and the like herein refer to a water-soluble alpha-glucan comprising glucose monomeric units linked together by glycosidic linkages, wherein at least about 40% of the glycosidic linkages are alpha-1,6. Alpha-1,6-glucan in some aspects comprises about, or at least about, 90%, 95%, or 100% alpha-1,6 glycosidic linkages. Other linkages that can optionally be present in alpha-1,6-glucan include alpha-1,2, alpha-1,3, and/or alpha-1,4 linkages.

An “alpha-1,2 branch” (and like terms) as referred to herein typically comprises a glucose that is alpha-1,2-linked to a dextran backbone; thus, an alpha-1,2 branch herein can also be referred to as an alpha-1,2,6 linkage. An alpha-1,2 branch herein typically has one glucose group (can optionally be referred to as a pendant glucose).

An “alpha-1,3 branch” (and like terms) as referred to herein typically comprises a glucose that is alpha-1,3-linked to a dextran backbone; thus, an alpha-1,3 branch herein can also be referred to as an alpha-1,3,6 linkage. An alpha-1,3 branch herein typically has one glucose group (can optionally be referred to as a pendant glucose).

The percent branching in an alpha-glucan herein typically refers to that percentage of all the linkages in the alpha-glucan that represent branch points. For example, the percent of alpha-1,2 branching in an alpha-glucan herein refers to that percentage of all the linkages in the glucan that represent alpha-1,2 branch points. Except as otherwise noted, linkage percentages disclosed herein are based on the total linkages of an alpha-glucan, or the portion of an alpha-glucan for which a disclosure specifically regards.

The terms “linkage”, “glycosidic linkage”, “glycosidic bond” and the like refer to the covalent bonds connecting the sugar monomers within a saccharide compound (oligosaccharides and/or polysaccharides). Examples of glycosidic linkages include 1,6-alpha-D-glycosidic linkages (herein also referred to as “alpha-1,6” linkages), 1,3-alpha-D-glycosidic linkages (herein also referred to as “alpha-1,3” linkages), 1,4-alpha-D-glycosidic linkages (herein also referred to as “alpha-1,4” linkages), and 1,2-alpha-D-glycosidic linkages (herein also referred to as “alpha-1,2” linkages).

The glycosidic linkage profile of an alpha-glucan or derivative thereof can be determined using any method known in the art. For example, a linkage profile can be determined using methods using nuclear magnetic resonance (NMR) spectroscopy (e.g., ¹³C NMR and/or ¹H NMR). These and other methods that can be used are disclosed in, for example, Food Carbohydrates: Chemistry, Physical Properties, and Applications (S. W. Cui, Ed., Chapter 3, S. W. Cui, Structural Analysis of Polysaccharides, Taylor & Francis Group LLC, Boca Raton, FL, 2005), which is incorporated herein by reference.

The term “molar substitution” (M.S.) as used herein refers to the moles of an organic group per monomeric unit of an alpha-glucan derivative herein. It is noted that the molar substitution value for an alpha-glucan derivative, for example, may have a very high upper limit, for example in the hundreds or even thousands.

The “molecular weight” of an alpha-glucan or alpha-glucan derivative herein can be represented as weight-average molecular weight (Mw) or number-average molecular weight (Mn), the units of which are in Daltons (Da) or grams/mole. Alternatively, molecular weight can be represented as DPw (weight average degree of polymerization) or DPn (number average degree of polymerization). The molecular weight of smaller alpha-glucan polymers such as oligosaccharides can optionally be provided as “DP” (degree of polymerization), which simply refers to the number of monomers comprised within the alpha-glucan; “DP” can also characterize the molecular weight of a polymer on an individual molecule basis. Various means are known in the art for calculating these various molecular weight measurements such as with high-pressure liquid chromatography (HPLC), size exclusion chromatography (SEC), or gel permeation chromatography (GPC). As used herein, DPw and DPn can be calculated from Mw and Mn, respectively, by dividing them by the molar mass of one monomer unit M₁. In the case of unsubstituted glucan polymer, M₁=162. In the case of a substituted (derivatized) glucan polymer, M₁=162+M_{f}×DoS, where M_{f} is molar mass of the substituting group, and DoS is degree of substitution (average number of substituted groups per one glucose unit of the glucan polymer).

An “alpha-glucan derivative” (and like terms) herein typically refers to an alpha-glucan that has been substituted with at least one type of organic group (e.g., an acyl group herein). The degree of substitution (DoS) of an alpha-glucan derivative herein can be up to about 3.0 (e.g., about 0.001 to about 3.0). An organic group herein that is an acyl group is linked to an alpha-glucan derivative via ester linkage. A precursor of an alpha-glucan derivative herein typically refers to the non-derivatized alpha-glucan used to make the derivative (can also be referred to as the alpha-glucan portion of the derivative). An organic group herein that is an acyl group is typically hydrophobic.

The term “degree of substitution” (DoS, or DS) as used herein refers to the average number of hydroxyl groups that are substituted with one or more types of organic group in each monomeric unit of an alpha-glucan derivative. The DoS of an alpha-glucan derivative herein can be stated with reference to the DoS of a specific substituent, or the overall DoS, which is the sum of the DoS values of different substituent types (e.g., if a mixed ester). Unless otherwise disclosed, when DoS is not stated with reference to a specific substituent type(s), the overall DoS is meant.

Terms used herein regarding “esters” (e.g., alpha-glucan ester derivative) can be as disclosed, for example, in U.S. Patent Appl. Publ. Nos. 2014/0187767, 2018/0155455, or 2020/0308371, or Int. Patent Appl. Publ. No. WO2021/252575, which are each incorporated herein by reference. The terms “alpha-glucan ester derivative”, “alpha-glucan ester compound”, “alpha-glucan ester” and the like are used interchangeably herein. An alpha-glucan ester derivative herein is an alpha-glucan that has been esterified with one or more organic groups (e.g., hydrophobic organic groups) such that the derivative has a DoS with one or more organic groups of up to about 3.0. An alpha-glucan ester derivative is termed an “ester” herein by virtue of comprising the substructure —C_{G}—O—CO—C—, where “—C_{G}—” represents a carbon atom of a monomeric unit (e.g., glucose) of the alpha-glucan ester derivative (where such carbon atom was bonded to a hydroxyl group [—OH] in the alpha-glucan precursor of the ester), and where “—CO—C—” is comprised in the acyl group. An example of an alpha-glucan ester derivative herein is benzoyl alpha-glucan.

The term “hydrophobic” herein can characterize a substituent organic group (substituent acyl group) that is nonpolar and has little or no affinity to water, and tends to repel water. Generally, such hydrophobicity can characterize an organic group as it exists in an aqueous composition herein, optionally taking into account the pH of the aqueous composition (in some aspects, the pH can be 4-10 or 5-9, or any pH as disclosed herein).

The terms “esterification reaction”, “esterification reaction composition” and the like herein refer to a reaction comprising at least an alpha-glucan as presently disclosed, an esterification agent and typically a solvent (“reaction solvent”, “liquid reaction medium”) (e.g., comprising water and/or one or more organic solvents). A reaction is placed under suitable conditions (e.g., solvent, time, temperature, pH) for esterification of one or more hydroxyl groups of glucose monomeric units of alpha-glucan with an organic group (acyl group) provided from the esterification agent, thereby yielding an alpha-glucan ester derivative. A reaction that has commenced and contains at least some amount of an alpha-glucan ester product can likewise be referred to as an esterification reaction, or as the case may be, a completed esterification reaction.

The terms “aqueous liquid”, “aqueous fluid”, “aqueous conditions”, “aqueous setting”, “aqueous system” and the like as used herein can refer to water or an aqueous solution. An “aqueous solution” herein can comprise one or more dissolved salts, where the maximal total salt concentration can be about 3.5 wt % in some embodiments.

An “aqueous composition” herein has a liquid component that comprises about, or at least about, 10, 20, 30, 40, 50, 60, 70, 80, 90, 95, 99, or 100 wt % water, for example. Examples of aqueous compositions include mixtures, solutions, dispersions (e.g., suspensions, colloidal dispersions) and emulsions, for example.

A “slurry” herein refers to a suspension of alpha-glucan solids and/or alpha-glucan ester solids in a solvent. Thus, all of, or at least a portion of, the alpha-glucan and/or alpha-glucan ester in a slurry is not dissolved (insoluble) in the solvent. An example of a solvent is a liquid medium used in an esterification reaction as presently disclosed.

An alpha-glucan or ester derivative thereof that is “aqueous-soluble” or “water-soluble” (and like terms) herein dissolves (or appreciably dissolves) in water or other aqueous conditions, optionally where the aqueous conditions are further characterized to have a pH of 4-9 (e.g., pH 6-8) and/or temperature of about 1 to 130° C. (e.g., 20-25° C.). In some aspects, an aqueous-soluble alpha-glucan or ester derivative thereof is soluble at 1% by weight or higher in pH 7 water at 25° C. In contrast, an alpha-glucan or ester derivative thereof that is “aqueous-insoluble” or “water-insoluble” (and like terms) does not dissolve under these conditions. In some aspects, less than 1.0 gram (e.g., no detectable amount) of an aqueous-insoluble alpha-glucan or ester derivative thereof dissolves in 1000 milliliters of such aqueous conditions (e.g., water at 23° C.).

The term “viscosity” as used herein refers to the measure of the extent to which a fluid (aqueous or non-aqueous) resists a force tending to cause it to flow. Various units of viscosity that can be used herein include centipoise (cP, cps) and Pascal-second (Pas), for example. A centipoise is one one-hundredth of a poise; one poise is equal to 0.100 kg·m⁻¹·s⁻¹. The terms “viscosity modifier”, “viscosity-modifying agent” and the like herein refer to anything that can alter/modify the viscosity of a fluid or aqueous composition.

The terms “polar organic solvent” and “water-miscible organic solvent” (and like terms) are used interchangeably herein. A polar organic solvent is capable of being dissolved in water or an aqueous solution. Thus, a polar organic solvent does not separate out into a different phase when added to water or an aqueous solution. A polar organic solvent contains carbon and at least one heteroatom (i.e., non-carbon or -hydrogen atom) such as oxygen, nitrogen, sulfur, or phosphorous. This contrasts with non-polar organic solvents, which generally comprise only carbon and hydrogen atoms. A polar organic solvent typically has a dielectric constant greater than about 4. A polar organic solvent contains dipoles due to polar bonds. The term “protic polar organic solvent” (and like terms) herein refers to a polar organic solvent that has one or more suitably labile hydrogen atoms that can form hydrogen bonds. A protic polar organic solvent generally contains hydrogen atoms bonded to an atom with electronegative character; e.g., there are one or more O—H, N—H, and/or S—H bonds.

The term “household care product” and like terms typically refer to products, goods and services relating to the treatment, cleaning, caring and/or conditioning of a home and its contents. The foregoing include, for example, chemicals, compositions, products, or combinations thereof having application in such care.

The terms “fabric”, “textile”, “cloth” and the like are used interchangeably herein to refer to a woven material having a network of natural and/or artificial fibers. Such fibers can be in the form of thread or yarn, for example.

A “fabric care composition” and like terms refer to any composition suitable for treating fabric in some manner. Examples of such a composition include laundry detergents and fabric softeners, which are examples of laundry care compositions.

A “detergent composition” herein typically comprises at least a surfactant (detergent compound) and/or a builder. A “surfactant” herein refers to a substance that tends to reduce the surface tension of a liquid in which the substance is dissolved. A surfactant may act as a detergent, wetting agent, emulsifier, foaming agent, and/or dispersant, for example.

The terms “heavy duty detergent”, “all-purpose detergent” and the like are used interchangeably herein to refer to a detergent useful for regular washing of white and/or colored textiles at any temperature. The terms “low duty detergent”, “fine fabric detergent” and the like are used interchangeably herein to refer to a detergent useful for the care of delicate fabrics such as viscose, wool, silk, microfiber, or other fabric requiring special care. “Special care” can include conditions of using excess water, low agitation, and/or no bleach, for example.

The term “personal care product” and like terms typically refer to products, goods and services relating to the treatment, cleaning, cleansing, caring or conditioning of a person. The foregoing include, for example, chemicals, compositions, products, or combinations thereof having application in such care.

The term “industrial product” and like terms typically refer to products, goods and services used in industrial and/or institutional settings, but typically not by individual consumers.

The terms “sequence identity”, “identity” and the like as used herein with respect to a polypeptide amino acid sequence (e.g., that of a glucosyltransferase) are as defined and determined in U.S. Patent Appl. Publ. No. 2017/0002336, which is incorporated herein by reference.

A composition herein that is “dry” or “dried” typically has less than 6, 5, 4, 3, 2, 1, 0.5, or 0.1 wt % water comprised therein.

The terms “percent by volume”, “volume percent”, “vol %”, “v/v %” and the like are used interchangeably herein. The percent by volume of a solute in a solution can be determined using the formula: [(volume of solute)/(volume of solution)]×100%.

The terms “percent by weight”, “weight percentage (wt %)”, “weight-weight percentage (% w/w)” and the like are used interchangeably herein. Percent by weight refers to the percentage of a material on a mass basis as it is comprised in a composition, mixture, or solution.

The terms “weight/volume percent”, “w/v %” and the like are used interchangeably herein. Weight/volume percent can be calculated as: ((mass [g] of material)/(total volume [mL] of the material plus the liquid in which the material is placed))×100%. The material can be insoluble in the liquid (i.e., be a solid phase in a liquid phase, such as with a dispersion), or soluble in the liquid (i.e., be a solute dissolved in the liquid).

The term “isolated” means a substance (or process) in a form or environment that does not occur in nature. A non-limiting example of an isolated substance includes any alpha-glucan ester derivative disclosed herein; a non-limiting example of an isolated process includes any alpha-glucan ester derivatization process (esterification reaction) disclosed herein. It is believed that the embodiments disclosed herein are synthetic/man-made (could not have been made or practiced except for human intervention/involvement), and/or have properties that are not naturally occurring.

The term “increased” as used herein can refer to a quantity or activity that is at least about 1%, 2%, 3%, 4%, 5%, 6%, 7%, 8%, 9%, 10%, 11%, 12%, 13%, 14%, 15%, 16%, 17%, 18%, 19%, 20%, 50%, 100%, or 200% more than the quantity or activity for which the increased quantity or activity is being compared. The terms “increased”, “elevated”, “enhanced”, “greater than”, “improved” and the like are used interchangeably herein.

Some aspects of the present disclosure concern a method of producing an ester derivative of an alpha-glucan (alpha-glucan ester derivative). Such a method can comprise, for example:
(a) contacting an alpha-glucan in a reaction composition with at least one esterification agent comprising an organic group (acyl group), wherein the reaction composition comprises a solvent (liquid reaction medium) that comprises (i) water/or and (ii) one or more organic solvents, wherein the solvent (liquid reaction medium) has a pH of at least about 9 or 10 (e.g., 9-10), wherein at least about 50% of the glycosidic linkages of the alpha-glucan are alpha-1,6 linkages, wherein at least one organic group (acyl group) is esterified to the alpha-glucan thereby producing an alpha-glucan ester derivative, wherein the alpha-glucan ester derivative has a degree of substitution (DoS) up to about 3.0 with the organic group (acyl group), and
(b) optionally isolating the alpha-glucan ester derivative from at least a portion of the solvent.
   Such a method can optionally be characterized herein as an esterification method/process. Step (a) of this method can optionally be characterized as an esterification step (or the like), while step (b) can optionally be characterized as an isolation or processing step (or the like).

An alpha-glucan can be used in an esterification reaction composition herein to produce an alpha-glucan ester derivative, for example. Such an alpha-glucan can optionally be characterized as an alpha-glucan precursor of an alpha-glucan ester. The glycosidic linkages of an alpha-glucan precursor herein typically are about, or at least about, 80%, 81%, 82%, 83%, 84%, 85%, 86%, 87%, 88%, 89%, 90%, 91%, 92%, 93%, 94%, 95%, 96%, 97%, 98%, 99%, or 100% alpha-glycosidic linkages. An example of a suitable alpha-glucan precursor for esterification is alpha-1,6-glucan (for producing alpha-1,6-glucan ester [i.e., dextran ester]).

An alpha-1,6-glucan precursor (i.e., dextran) for esterification herein can comprise about, or at least about, 40%, 50%, 60%, 70%, 80%, 85%, 90%, 91%, 92%, 93%, 94%, 95%, 96%, 97%, 98%, 99%, 99.5%, or 100% alpha-1,6 glycosidic linkages, for example. In some aspects, a substantially linear dextran can comprise 5%, 4%, 3%, 2%, 1%, 0.5% or less glycosidic branches (a linear dextran has 100% alpha-1,6 linkages). If present, glycosidic branches from a dextran are typically short, being one (pendant), two, or three glucose monomers in length. In some aspects, a dextran can comprise about, or less than about, 50%, 40%, 30%, 20%, 15%, 10%, 9%, 8%, 7%, 6%, 5%, 4%, 3%, 2%, 1%, 0.5%, or 0% alpha-1,4, alpha-1,3 and/or alpha-1,2 glycosidic linkages. Typically, such linkages exist entirely, or almost entirely, as branch points from dextran.

Dextran herein can have alpha-1,2, alpha-1,3, and/or alpha-1,4 branches, for example. In some aspects, about, at least about, or less than about, 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 30%, 35%, 40%, 45%, 50%, 2-25%, 2-20%, 2-15%, 2-10%, 3-25%, 3-20%, 3-15%, 3-10%, 5-30%, 5-25%, 5-20%, 5-15%, 5-10%, 7-13%, 8-12%, 9-11%, 10-30%, 10-25%, 10-22%, 10-20%, 10-15%, 12-20%, 12-18%, 14-20%, 14-18%, 15-30%, 15-25%, 15-20%, 15-18%, 15-17%, 20-45%, 20-40%, 20-35%, 20-30%, 20-25%, 30-45%, or 30-40% of all the glycosidic linkages of a branched dextran are alpha-1,2, alpha-1,3, and/or alpha-1,4 glycosidic branch linkages. Such branches typically are mostly (>90% or >95%), or all (100%), a single glucose monomer in length. In some aspects, dextran with alpha-1,2-branching can be produced enzymatically according to the procedures in U.S. Patent Appl. Publ. Nos. 2017/0218093 or 2018/0282385 (both incorporated herein by reference) where, for example, an alpha-1,2-branching enzyme such as GTFJ18T1 or GTF9905 can be added during or after the production of the dextran. In some aspects, any other enzyme known to produce alpha-1,2-branching can be used. Dextran with alpha-1,3-branching can be prepared, for example, as disclosed in Vuillemin et al. (2016, J. Biol Chem. 291:7687-7702) or U.S. Patent Appl. Publ. No. 2022/0267745, which are incorporated herein by reference.

Any of the forgoing glycosidic linkage and/or branching profiles (values or ranges) of a dextran can likewise characterize a dextran ester derivative herein, for example.

Dextran herein can have a DPw, DPn, or DP of about, at least about, or less than about, 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, 40, 45, 50, 85, 90, 95, 100, 105, 110, 150, 200, 250, 300, 400, 500, 1000, 1500, 2000, 2500, 3000, 4000, 5000, 6000, 8-20, 8-30, 8-100, 8-500, 3-4, 3-5, 3-6, 3-7, 3-8, 4-5, 4-6, 4-7, 4-8, 5-6, 5-7, 5-8, 6-7, 6-8, 7-8, 90-120, 95-120, 100-120, 105-120, 110-120, 115-120, 90-115, 95-115, 100-115, 105-115, 110-115, 90-110, 95-110, 100-110, 105-110, 90-105, 95-105, 100-105, 90-100, 95-100, 90-95, 85-95, 85-90, 5-100, 5-250, 5-500, 5-1000, 5-1500, 5-2000, 5-2500, 5-3000, 5-4000, 5-5000, 5-6000, 10-100, 10-250, 10-500, 10-1000, 10-1500, 10-2000, 10-2500, 10-3000, 10-4000, 10-5000, 10-6000, 25-100, 25-250, 25-500, 25-1000, 25-1500, 25-2000, 25-2500, 25-3000, 25-4000, 25-5000, 25-6000, 50-100, 50-250, 50-500, 50-1000, 50-1500, 50-2000, 50-2500, 50-3000, 50-4000, 50-5000, 50-6000, 100-250, 100-400, 100-500, 100-1000, 100-1500, 100-2000, 100-2500, 100-3000, 100-4000, 100-5000, 100-6000, 250-500, 250-1000, 250-1500, 250-2000, 250-2500, 250-3000, 250-4000, 250-5000, 250-6000, 300-2800, 300-3000, 350-2800, 350-3000, 500-1000, 500-1500, 500-2000, 500-2500, 500-2800, 500-3000, 500-4000, 500-5000, 500-6000, 600-1550, 600-1850, 600-2000, 600-2500, 600-3000, 750-1000, 750-1250, 750-1500, 750-2000, 750-2500, 750-3000, 750-4000, 750-5000, 750-6000, 900-1250, 900-1500, 900-2000, 1000-1250, 1000-1400, 1000-1500, 1000-2000, 1000-2500, 1000-3000, 1000-4000, 1000-5000, 1000-6000, or 1100-1300, for example. The Mw of dextran in some aspects can be about, at least about, or less than about, 0.1, 0.125, 0.15, 0.175, 0.2, 0.24, 0.25, 0.5, 0.75, 1, 2, 3, 4, 5, 6, 7, 8, 9, 10, 20, 30, 40, 50, 60, 70, 80, 90, 100, 110, 120, 130, 140, 150, 160, 170, 180, 190, 200, 0.1-0.2, 0.125-0.175, 0.13-0.17, 0.135-0.165, 0.14-0.16, 0.145-0.155, 10-80, 20-70, 30-60, 40-50, 50-200, 60-200, 70-200, 80-200, 90-200, 100-200, 110-200, 120-200, 50-180, 60-180, 70-180, 80-180, 90-180, 100-180, 110-180, 120-180, 50-160, 60-160, 70-160, 80-160, 90-160, 100-160, 110-160, 120-160, 50-140, 60-140, 70-140, 80-140, 90-140, 100-140, 110-140, 120-140, 50-120, 60-120, 70-120, 80-120, 90-120, 90-110, 100-120, 110-120, 50-110, 60-110, 70-110, 80-110, 90-110, 100-110, 50-100, 60-100, 70-100, 80-100, 90-100, or 95-105 million Daltons. The Mw of dextran in some aspects can be about, at least about, or less than about, 1, 5, 7.5, 10, 12.5, 15, 20, 30, 40, 50, 60, 70, 80, 90, 100, 150, 200, 250, 300, 400, 500, 600, 700, 800, 900, 1000, 1250, 1500, 1750, 2000, 1-2000, 1-1000, 1-500, 1-400, 1-300, 1-200, 1-100, 1-50, 10-2000, 10-1000, 10-500, 10-400, 10-300, 10-200, 10-100, 10-50, 20-2000, 20-1000, 20-500, 20-400, 20-300, 20-200, 20-100, 20-50, 30-2000, 30-1000, 30-500, 30-400, 30-300, 30-200, 30-100, 30-50, 40-2000, 40-1000, 40-500, 40-400, 40-300, 40-200, 40-100, 40-50, 50-2000, 50-1000, 50-500, 50-400, 50-300, 50-200, 100-2000, 100-1000, 100-500, 100-400, 100-300, 100-200, 200-2000, 20-1000, 200-500, 200-400, 200-300, 7.5-10, 7.5-12.5, 7.5-15, 7.5-20, 7.5-30, 10-12.5, 10-15, 10-20, 10-30, 15-25, 15-30, 40-60, 45-55, 190-210, or 290-310 kDa, for example. The molecular weight of dextran can be calculated, if desired, based on any of the foregoing dextran DPw, DPn, or DP values. Any of the forgoing DPw, DPn, DP, or Dalton values/ranges can characterize a dextran herein before, or after, it has optionally been branched (e.g., alpha-1,2 and/or alpha-1,3), for instance. In some aspects, any of the forgoing DPw, DPn, DP, or Dalton values or ranges can characterize a dextran ester derivative herein. The molecular weight of a dextran ester herein can be calculated, for example, based on any of the foregoing dextran DPw, DPn, DP, or Dalton values, further taking into account the ester's DoS and type of ester group(s).

Dextran herein can be as disclosed (e.g., molecular weight, linkage/branching profile, production method), for example, in U.S. Patent Appl. Publ. Nos. 2016/0122445, 2017/0218093, 2018/0282385, 2020/0165360, or 2019/0185893, which are each incorporated herein by reference. In some aspects, a dextran for ester derivatization can be one produced in a suitable reaction comprising glucosyltransferase (GTF) 0768 (SEQ ID NO:1 or 2 of US2016/0122445), GTF 8117, GTF 6831, or GTF 5604 (these latter three GTF enzymes are SEQ ID NOs: 30, 32 and 33, respectively, of US2018/0282385), or a GTF comprising an amino acid sequence that is at least 90%, 91%, 92%, 93%, 94%, 95%, 96%, 97%, 98%, or 99% identical to the amino acid sequence of GTF 0768, GTF 8117, GTF 6831, or GTF 5604.

An ester derivative of an alpha-glucan of the present disclosure (e.g., an alpha-glucan ester as produced by an esterification process herein) can have a degree of substitution (DoS) up to about 3.0 (e.g., 0.001 to 3.0) with at least one organic group (acyl group) that is ester-linked to the alpha-glucan. The DoS can be about, at least about, or up to about, 0.001, 0.0025, 0.005, 0.01, 0.02, 0.025, 0.03, 0.04, 0.05, 0.06, 0.07, 0.075, 0.08, 0.09, 0.1, 0.15, 0.2, 0.25, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, or 3.0 (DoS can optionally be expressed as a range between any two of these values), for example. Some examples of DoS ranges herein include 0.005-2.0, 0.005-1.9, 0.005-1.8, 0.005-1.7, 0.005-1.6, 0.005-1.5, 0.005-1.25, 0.005-1.0, 0.005-0.9, 0.005-0.8, 0.005-0.7, 0.005-0.6, 0.005-0.5, 0.01-2.0, 0.01-1.9, 0.01-1.8, 0.01-1.7, 0.01-1.6, 0.01-1.5, 0.01-1.25, 0.01-1.0, 0.01-0.9, 0.01-0.8, 0.01-0.7, 0.01-0.6, 0.01-0.5, 0.01-0.25, 0.01-0.1, 0.03-2.0, 0.03-1.9, 0.03-1.8, 0.03-1.7, 0.03-1.6, 0.03-1.5, 0.03-1.25, 0.03-1.0, 0.03-0.9, 0.03-0.8, 0.03-0.7, 0.03-0.6, 0.03-0.5, 0.03-0.25, 0.03-0.1, 0.05-2.0, 0.05-1.9, 0.05-1.8, 0.05-1.7, 0.05-1.6, 0.05-1.5, 0.05-1.25, 0.05-1.0, 0.05-0.9, 0.05-0.8, 0.05-0.7, 0.05-0.6, 0.05-0.5, 0.1-2.0, 0.1-1.9, 0.1-1.8, 0.1-1.7, 0.1-1.6, 0.1-1.5, 0.1-1.25, 0.1-1.0, 0.1-0.9, 0.1-0.8, 0.1-0.7, 0.1-0.6, 0.1-0.5, 0.15-2.0, 0.15-1.9, 0.15-1.8, 0.15-1.7, 0.15-1.6, 0.15-1.5, 0.15-1.25, 0.15-1.0, 0.15-0.9, 0.15-0.8, 0.15-0.7, 0.15-0.6, 0.15-0.5, 0.2-2.0, 0.2-1.9, 0.2-1.8, 0.2-1.7, 0.2-1.6, 0.2-1.5, 0.2-1.25, 0.2-1.0, 0.2-0.9, 0.2-0.8, 0.2-0.7, 0.2-0.6, 0.2-0.5, 0.25-2.0, 0.25-1.9, 0.25-1.8, 0.25-1.7, 0.25-1.6, 0.25-1.5, 0.25-1.25, 0.25-1.0, 0.25-0.9, 0.25-0.8, 0.25-0.7, 0.25-0.6, 0.25-0.5, 0.3-2.0, 0.3-1.9, 0.3-1.8, 0.3-1.7, 0.3-1.6, 0.3-1.5, 0.3-1.25, 0.3-1.0, 0.3-0.9, 0.3-0.8, 0.3-0.7, 0.3-0.6, 0.3-0.5, 0.4-2.0, 0.4-1.9, 0.4-1.8, 0.4-1.7, 0.4-1.6, 0.4-1.5, 0.4-1.25, 0.4-1.0, 0.4-0.9, 0.4-0.8, 0.4-0.7, 0.4-0.6 and 0.4-0.5.

Since there are at most three hydroxyl groups in a glucose monomeric unit of an alpha-glucan, the overall DoS of an alpha-glucan ester derivative herein can be no higher than 3.0. It would be understood by those skilled in the art that, since an alpha-glucan ester derivative as presently disclosed has a DoS with at least one type of organic group (acyl group) in ester linkage (e.g., between about 0.001 to about 3.0), all the substituents of an alpha-glucan ester derivative cannot only be hydroxyl.

An ester derivative of an alpha-glucan of the present disclosure (e.g., an alpha-glucan ester as produced by an esterification process herein) can be substituted with at least one hydrophobic organic group (hydrophobic acyl group) that is ester-linked to the alpha-glucan. An alpha-glucan derivative as presently disclosed can be derivatized with one, two, three, or more different types of esterified hydrophobic acyl groups herein, for example. A hydrophobic acyl group can be represented as —CO—R′, wherein R′ is hydrophobic and comprises a chain having at least one carbon atom (i.e., one or more carbon atoms); the carbonyl (—CO—) of the acyl group is linked to the alpha-glucan monomer (e.g., glucose) via an oxygen atom of the monomer. R′ can be linear, branched, or cyclic, for example. R′ can be saturated or unsaturated, and/or comprise up to 29 carbon atoms, for example.

A hydrophobic acyl group in some aspects can be termed as a “Cₙ acyl group” (or other like terms), where n is an integer of 2 or greater and represents the number of carbon atoms in the acyl group, including the carbonyl carbon atom. A Cₙ acyl group typically is linear, and can be either saturated or unsaturated. The first carbon (carbon-1) of a Cₙ acyl group is its carbonyl carbon. In some aspects, a Cₙ acyl group can be an ethanoyl (C₂), propanoyl (C₃), butanoyl (C₄), pentanoyl (C₅), hexanoyl (C₆), heptanoyl (C₇), octanoyl (C₈), nonanoyl (C₉), decanoyl (C₁₀), undecanoyl (C₁₁), dodecanoyl (C₁₂), tridecanoyl (C₁₃), tetradecanoyl (C₁₄), pentadecanoyl (C₁₅), hexadecanoyl (C₁₆), heptadecanoyl (C₁₇), octadecanoyl (C₁₈), nonadecanoyl (C₁₉), eicosanoyl (C₂₀), uneicosanoyl (C₂₁), docosanoyl (C₂₂), tricosanoyl (C₂₃), tetracosanoyl (C₂₄), pentacosanoyl (C₂₅), hexacosanoyl (C₂₆), C₂₇, C₂₈, C₂₉, or C₃₀ acyl group. These particular Cₙ acyl groups are saturated. Common names for some of the above-listed acyl groups are acetyl (ethanoyl group), propionyl (propanoyl group), butyryl (butanoyl group), valeryl (pentanoyl group), caproyl (hexanoyl group); enanthyl (heptanoyl group), caprylyl (octanoyl group), pelargonyl (nonanoyl group), capryl (decanoyl group), lauroyl (dodecanoyl group), myristyl (tetradecanoyl group), palmityl (hexadecanoyl group), stearyl (octadecanoyl group), arachidyl (eicosanoyl group), behenyl (docosanoyl group), lignoceryl (tetracosanoyl group), and cerotyl (hexacosanoyl group). In some aspects, an acyl group can be a C₁₀ to C₁₄ acyl group, meaning that the acyl group can be any one of a C₁₀, C₁₁, C₁₂, C₁₃, or C₁₄ acyl group (this particular Cₙ range nomenclature applies, accordingly, to other Cₙ ranges herein). In some aspects, an acyl group can be a C₂ to C₂₆, C₄ to C₂₀, C₆ to C₁₈, C₈ to C₁₈, C₁₀ to C₁₈, C₁₂ to C₁₈, C₆ to C₁₆, C₈ to C₁₆, C₁₀ to C₁₆, C₁₂ to C₁₆, C₆ to C₁₄, C₈ to C₁₄, C₁₀ to C₁₄, C₁₂ to C₁₄, C₆ to C₁₂, C₈ to C₁₂, or C₁₀ to C₁₂ acyl group.

A hydrophobic acyl group in some aspects can be unsaturated. An unsaturated acyl group can comprise one, two, three, four, five, six, or more double-bonds, for example. An unsaturated acyl group in some aspects can comprise one or more double-bonds spanning carbons (i) 4 and 5), (ii) 5 and 6, (iii) 6 and 7, (iv) 8 and 9, (v) 9 and 10, (vi) 11 and 12, (vii) 12 and 13, (viii) 14 and 15, (ix) 15 and 16, (x) 16 and 17, (xi) 17 and 18, and/or (xii) 18 and 19 of the acyl group, where carbon number is counted starting from the carbonyl carbon (i.e., carbon-1) of the acyl group. Some suitable combinations of double-bonds of an acyl group are as reflected in the below list of unsaturated acyl groups. While a double-bond herein of an acyl group can be in a cis or trans orientation, it typically is in the cis orientation. An unsaturated acyl group can be derived (derivable) from a fatty acid in some aspects. Examples of unsaturated acyl groups herein include (11Z,14Z)-icosadienoyl, (11Z,14Z,17Z)-icosatrienoyl, (4Z)-hexadecenoyl, (4Z,7Z,10Z,13Z,16Z)-docosapentaenoyl, (4Z,7Z,10Z, 13Z, 16Z, 19Z)-docosahexaenoyl, (5Z,8Z,11Z,14Z,17Z)-icosapentaenoyl, (5Z,9Z,12Z)-octadecatrienoyl, (5Z,9Z,12Z, 15Z)-octadecatetraenoyl, (6Z,9Z,12Z, 15Z)-octadecatetraenoyl, (7Z,10Z)-hexadecadienoyl, (7Z,10Z,13Z)-hexadecatrienoyl, (7Z,10Z,13Z, 16Z)-docosatetraenoyl, (7Z,10Z,13Z,16Z, 19Z)-docosapentaenoyl, (8E,10E,12Z)-octadecatrienoyl, (8Z,11Z,14Z)-icosatrienoyl, (8Z,11Z,14Z,17Z)-icosatetraenoyl, (9Z)-octadec-9-en-12-ynoyl, (9Z,11E,13E)-octadecatrienoyl, (9Z,11E,13Z)-octadeca-9,11,13-trienoyl, (9Z,12E)-hexadecadienoyl, (9Z,12E)-octadecadienoyl, (9Z,12Z)-octadeca-9,12-dien-6-ynoyl, (9Z,12Z,15Z)-octadeca-9,12,15-trien-6-ynoyl, (Z)-tetradec-7-enoyl, cis, cis-tetradeca-5,8-dienoyl, cis-tetradec-5-enoyl, arachidonoyl, docosenoyl, dodecenoyl, eleostearoyl, heptatrienoyl, icosenoyl, linoleoyl, myristoleoyl, octadec-9-ynoyl, octadecenoyl, palmitoleoyl, and oleoyl.

A hydrophobic acyl group in some aspects can comprise an aryl group. An aryl acyl group can comprise a benzoyl group (—CO—C₆H₅), for example, which can also be referred to as a benzoate group. An aryl acyl group in some aspects can comprise a benzoyl group substituted with at least one halogen (“X”; e.g., Cl, F), alkyl, halogenated alkyl, ether, cyano, or aldehyde group, or combination thereof, such as represented by the following Structures I (a) through I (r):

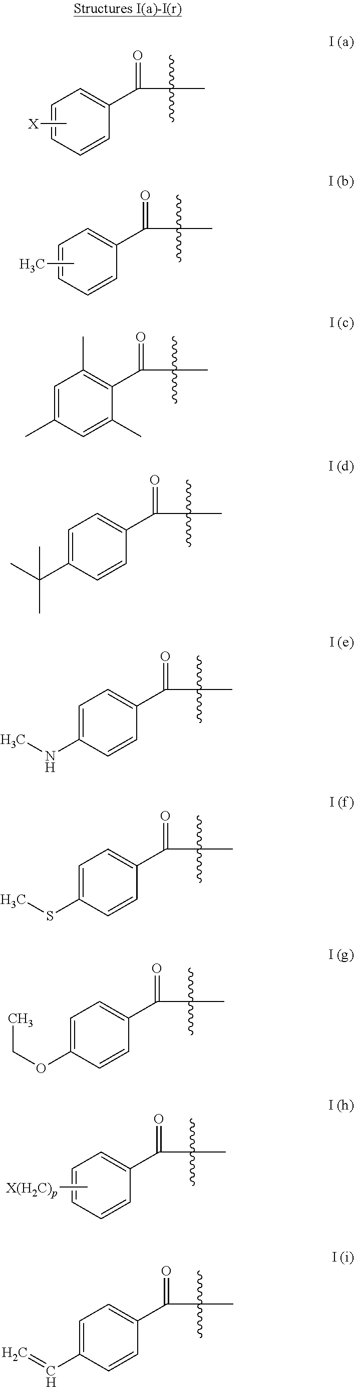

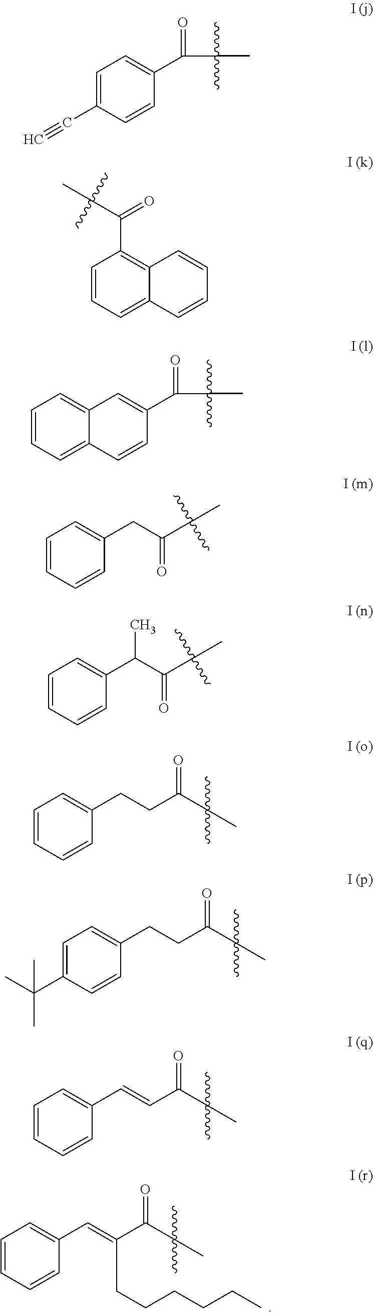

A hydrophobic acyl group in some aspects can comprise a branched group. Examples herein of acyl groups that are branched include 2-methylpropanoyl, 2-methylbutanoyl, 2,2-dimethylpropanoyl, 3-methylbutanoyl, 2-methylpentanoyl, 3-methylpentanoyl, 4-methylpentanoyl, 2,2-dimethylbutanoyl, 2,3-dimethylbutanoyl, 3,3-dimethylbutanoyl, 2-ethylbutanoyl and 2-ethylhexanoyl.

An alpha-glucan ester derivative of the present disclosure can be characterized in some aspects to be a mixed ester by virtue of comprising two or more different types of esterified acyl groups, such as any disclosed herein. Merely as examples, a mixed alpha-glucan ester can comprise at least (i) an acetyl, propionyl, or butyryl acyl group (e.g., DoS of about 0.05-0.15 or 0.05-0.2) herein and (ii) an aryl acyl group (e.g., a benzoyl group) herein (e.g., DoS of about 0.2-1.0, 0.2-0.5, 0.2-0.4, 0.2-0.3, 0.3-1.0, 0.3-0.5, or 0.3-0.4). In some aspects, such an alpha-glucan ester can comprise alpha-1,2- and/or alpha-1,3-branched (e.g., about 15-25% branched) alpha-1,6-glucan (e.g., about 10-70, 20-60, or 30-50 kDa) as its glucan component. While an alpha-glucan ester derivative in some aspects does not comprise any other type of substitution group aside from ester groups, one or more other types of substitution group can be present in other aspects.

Hydrophobic acyl groups of an alpha-glucan ester derivative herein can be as disclosed, for example, in U.S. Patent Appl. Publ. Nos. 2014/0187767, 2018/0155455, or 2020/0308371, or International Patent Appl. Publ. No. WO2021/252575, which are each incorporated herein by reference.

An esterification agent for an ester derivatization method of the present disclosure can be an acyl halide (acid halide) comprising any acyl group as disclosed herein, for example. The halide of an acyl halide herein can be chloride, fluoride, or bromide, for example. Some illustrative examples of an acyl halide include aroyl halide (e.g., a benzoyl halide such as benzoyl chloride), acetyl halide (e.g., acetyl chloride), propionyl halide (e.g., propionyl chloride), butyryl halide (e.g., butyryl chloride) and lauroyl halide (e.g., lauroyl chloride).

An esterification agent for an ester derivatization method in some aspects can be an acid anhydride comprising any acyl group as disclosed herein (or comprising a precursor to an acyl group herein), for example. Some illustrative examples of an acid anhydride include aryl anhydride (aroyl anhydride) (e.g., benzoic anhydride [benzoyl anhydride]), acetic anhydride, propionic anhydride and butyric anhydride. Yet, in some aspects, an esterification agent can be an enoate ester such as vinyl benzoate.

The concentration (initial concentration) of an esterification agent in an esterification reaction composition herein can be about 10, 25, 50, 75, 100, 125, 150, 175, 200, 10-200, 10-100, 10-50, 25-200, 25-100, 25-50, 10-25, 100-200, or 150-200 g/L, for example.

There can be one, two, or more esterification agents in an esterification reaction composition, for example. When two or more esterification agents are used, they can be all added to a reaction composition at the same time (or about the same time, such as within about 5, 10, 15, or 20 minutes), or added sequentially (e.g., where addition of a second or any subsequent agent is added following the completion (or at least about 90% or 95% completion) of alpha-glucan esterification by the previously added agent).

A solvent (liquid reaction medium, reaction solvent) of an ester reaction composition in some aspects can comprise (i) water/or and (ii) one or more organic solvents. The water content of the solvent can be about 5%, 10%, 15%, 20%, 25%, 30%, 35%, 40%, 45%, 50%, 55%, 60%, 65%, 70%, 75%, 80%, 85%, 90%, 95%, 100%, 5-65%, 5-60%, 5-50%, 5-40%, 5-30%, 5-20%, 5-15%, 5-10%, 10-65%, 10-60%, 10-50%, 10-40%, 10-30%, 10-20%, 10-15%, 20-65%, 20-60%, 20-50%, 20-40%, 20-30%, 30-65%, 30-60%, 30-50%, 30-40%, 40-80%, 50-90%, or 60-100% by weight, for example. The non-water balance (i.e., up to 100 wt %) of a solvent herein can comprise one, two (e.g., ~50: ~ 50 ratio), three (e.g., ~33: ~ 33: ~ 33 ratio), or more organic solvents (e.g., as disclosed herein).

An organic solvent comprised in an ester reaction solvent herein can comprise one or more of toluene, isopropanol (“IPA”, isopropyl alcohol), acetone, methyl ethyl ketone, acetonitrile, 1,4-dioxane, 2-butanol, or tetrahydrofuran, for example. In some particular aspects, an organic solvent comprises toluene or IPA.

The pH of the solvent of an esterification reaction composition as presently disclosed can be about, or at least about, 9.0, 9.5, 10.0, 10.5, 11.0, 11.5, 12, 12.5, 10-12.5, 10-12, 10-11.5, 10-11, 9-12.5, 9-12, 9-11.5, 9-11, 9-10.5, or 9-10 in some aspects. It would be understood that, though pH can be stated as characterizing a slurry or esterification reaction composition herein, for example, pH is a feature of the solvent of the slurry or esterification reaction. The pH of a solvent (or slurry or reaction, e.g.) can be adjusted to be as disclosed herein by adding a suitable base. Examples of a suitable base include an alkali hydroxide (e.g., a metal hydroxide such as NaOH, KOH, or LiOH), an organic base such as guanidine, pyridine, 4-dimethylaminopyridine, or 1,2-dimethylimidazole, or an organic hydroxide such as a tetraalkyl ammonium hydroxide (e.g., tetraethyl ammonium hydroxide or tetramethylammonium hydroxide), or any base as disclosed, for example, in Int. Pat. Appl. Publ. Nos. WO2015/200612 or WO2015/200590, or U.S. Pat. Appl. Publ. Nos. 2017/0208823 or 2017/0204203, which are each incorporated herein by reference.

Typically, an esterification reaction composition herein is in the form of a slurry (suspension). While a portion of the alpha-glucan is dissolved in the solvent in such aspects, the other portion of the alpha-glucan is suspended in the solvent. In other words, a portion of the alpha-glucan entered into an esterification reaction is insoluble in the reaction solvent, while the other portion is soluble in the reaction solvent. In some aspects, about 20%, 30%, 40%, 50%, 60%, 70%, 80%, 90%, 20-90%, 20-80%, 20-70%, 20-60%, 20-50%, 30-90%, 30-80%, 30-70%, 30-60%, 30-50%, 40-90%, 40-80%, 40-70%, 40-60%, 40-50%, 50-90%, 50-80%, 50-70%, 50-60%, 60-90%, 60-80%, 60-70%, 70-90%, 70-80%, or 80-90% by weight of the alpha-glucan entered into an esterification reaction composition is suspended (insoluble), while the other portion is dissolved in the solvent.

In some aspects, step (a) of contacting an alpha-glucan in an esterification reaction composition can comprise at least mixing the alpha-glucan into a preparation comprising (i) water and (ii) toluene or isopropanol (or any other organic solvent disclosed herein) to provide a slurry (suspension) herein, and then adjusting the pH of the slurry to at least about 9 or 10 (e.g., 9-10). This process typically dissolves at least a portion of (but typically not all of) the alpha-glucan that had been insoluble in the slurry before the pH adjustment. In some aspects, step (a) of contacting an alpha-glucan in an esterification reaction composition can comprise at least mixing the alpha-glucan into a preparation already having a pH of at least about 9 or 10 (e.g., 9-10) and comprising (i) water and (ii) toluene or isopropanol (or any other organic solvent disclosed herein), thereby providing a slurry, and optionally adjusting the pH to at least about 9 or 10 (e.g., 9-10) if the pH of the slurry dropped below 9 or 10 when the alpha-glucan was mixed in.

In some aspects, step (a) of contacting an alpha-glucan in an esterification reaction composition can comprise at least mixing the alpha-glucan into water, then mixing this preparation with toluene or isopropanol (or any other organic solvent disclosed herein) to provide a slurry, and then adjusting the pH of the slurry to at least about 9 or 10 (e.g., 9-10). In some aspects, step (a) of contacting an alpha-glucan in an esterification reaction composition can comprise at least mixing the alpha-glucan into toluene or isopropanol (or any other organic solvent disclosed herein), then mixing this preparation with water to provide a slurry, and then adjusting the pH of the slurry to at least about 9 or 10 (e.g., 9-10).

The concentration of an alpha-glucan in an esterification reaction composition herein can be about, or at least about, 10, 25, 50, 75, 100, 150, 200, 250, 300, 10-300, 10-250, 10-200, 10-100, 10-50, 25-300, 25-250, 25-200, 25-100, 25-50, 50-300, 50-250, 50-200, 50-100, 150-300, 150-250, or 150-200 g/L, for example. The temperature of an esterification reaction composition herein can be about, at least about, or up to about, −10, −5, −2.5, 0, 5, 2.5, 5, 10, 15, 20, 25, 30, 40, 50, 60, 70, 80, 90, 100, 110, 120, 130, 140, 150, −2.5-10, −2.5-5, 0-10, 0-5, 10-30, 15-30, 20-30, 50-150, 50-140, 50-130, 60-150, 60-140, 60-130, 70-150, 70-140, 70-130, 60-80, or 110-130° C., for example. In some aspects, an esterification reaction can proceed for about, or at least about, 1, 2, 3, 4, 5, 6, 7, 8, 1-8, 2-8, 1-6, or 2-6 hours.

In some aspects, a preparation comprising an alpha-glucan, water and/or one or more organic solvents, and that has been alkalized to a pH of at least about 9 or 10 (e.g., 9-10), but that does not have an esterification agent (i.e., the preparation is not yet an esterification reaction composition herein), is at a temperature of about-2.5, 0, 5, 10, 15, 20, 25, 30, 40, 50, 60, 70, 80, 90, 100, 110, 120, 130, 140, 150, −2.5-10, −2.5-5, 0-10, 0-5, 10-30, 15-30, 20-30, 50-150, 50-140, 50-130, 60-150, 60-140, 60-130, 70-150, 70-140, 70-130, 60-80, or 110-130° C.

An esterified alpha-glucan derivative produced in an esterification reaction composition herein can optionally be isolated. Typically, one or more washing steps can be conducted. Washing in some aspects can comprise precipitating, with one or more polar organic solvents, alpha-glucan ester product from a completed ester reaction composition. Washing can also target alpha-glucan ester product that already precipitated into the solvent after its formation during the reaction, in some aspects (i.e., such product is not precipitated by the polar organic solvent). In some aspects, washing also targets alpha-glucan that was not esterified during the reaction process, typically since it was not soluble in the esterification reaction composition. Washing is typically followed by removing liquid (i.e., at least the polar organic solvent[s] and esterification reaction solvent) from the solids. Removal of liquid from solids can be performed using a filtration funnel, centrifuge, press filter, or any other method or equipment that allows for removal of liquids from solids, for example. Washing can be performed one, two, three, or more times, for example. In some aspects, the volume of polar organic solvent used for washing/precipitation can be about, or at least about, 0.5-, 1-, 1.5-, 2-, 2.5-, or 3-times the volume of the esterification reaction composition. The isolated/washed solids can then optionally be dried, such as by vacuum drying, air drying, or freeze drying, optionally with heat applied (e.g., any suitable temperature disclosed herein).

A polar organic solvent herein, such as for washing/precipitation, typically comprises one type of polar organic solvent, but can optionally include two, three, or more polar organic solvents. A polar organic solvent herein typically is comprised only of the polar organic solvent(s), but can in some instances comprise about, or less than about, 30%, 20%, 10%, 5%, or 1% water by weight. A polar organic solvent in some aspects can be protic. Examples of a protic polar organic solvent herein include alcohol (e.g., methanol, ethanol, isopropanol [IPA], 1-propanol, tert-butyl alcohol, n-butanol, iso-butanol), methyl formamide and formamide. Additional examples of protic polar organic solvents herein include ethylene glycol, 2-methoxyethanol, 1-methoxy-2-propanol, glycerol, 1,2-propanediol, and 1,3-propanetriol.

Some aspects of the present disclosure regard a product/composition comprising an alpha-glucan ester derivative as disclosed herein. For instance, a product/composition can comprise an alpha-glucan ester derivative produced by a method/process as presently disclosed. A product/composition can comprise a hydrophobic alpha-glucan ester derivative (i.e., an alpha-glucan herein substituted with one or more different hydrophobic ester/acyl groups), for example. An alpha-glucan ester of a product/composition herein can have any glycosidic linkage, molecular weight, DoS, and/or acyl group substitution profile as presently disclosed, amongst any other disclosed features, for example. An alpha-glucan ester derivative product can be provided as a purified product (e.g., >99% or 99.5% by weight), or in a form that has not been purified (e.g., crude esterification reaction product); any of these forms can be used accordingly to produce a product/composition comprising an alpha-glucan ester derivative.

A composition as presently disclosed can be an aqueous composition (e.g., a solution, or a mixture such as colloidal dispersion or emulsion) or a dry composition (e.g., dry powder), for example. In some aspects, a composition herein can comprise about, at least about, or less than about, 0.01, 0.05, 0.1, 0.2, 0.25, 0.3, 0.4, 0.5, 0.6, 0.7, 0.75, 0.8, 0.9, 1.0, 1.2, 1.25, 1.4, 1.5, 1.6, 1.75, 1.8, 2.0, 2.25, 2.5, 3.0, 3.5, 4.0, 4.5, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 99.5 wt % or w/v % of an alpha-glucan ester derivative herein. A composition can comprise a range between any two of these wt % or w/v % values (e.g., 5-50, 5-45, 5-40, 5-35, 5-30, 5-25, 5-20, 5-15, or 5-10 wt % or w/v %), for example. The liquid component of an aqueous composition can be an aqueous fluid such as water or aqueous solution, for instance. The solvent of an aqueous solution typically is water, or can comprise about, or at least about, 10, 20, 30, 40, 50, 60, 70, 80, 90, 95, 98, or 99 wt % water, for example.

An aqueous composition herein can have a viscosity of about, at least about, or less than about, 1, 5, 10, 100, 200, 300, 400, 500, 600, 700, 1000, 2000, 3000, 4000, 5000, 6000, 7000, 8000, 9000, 10000, 15000, 1-300, 10-300, 25-300, 50-300, 1-250, 10-250, 25-250, 50-250, 1-200, 10-200, 25-200, 50-200, 1-150, 10-150, 25-150, 50-150, 1-100, 10-100, 25-100, or 50-100 centipoise (cps), for example. Viscosity can be as measured with an aqueous composition herein at any temperature between about 3° C. to about 80° C., for example (e.g., 4-30° C., 15-30° C., 15-25° C.). Viscosity typically is as measured at atmospheric pressure (about 760 torr) or a pressure that is +10% thereof. Viscosity can be measured using a viscometer or rheometer, for example, and can optionally be as measured at a shear rate (rotational shear rate) of about 0.1, 0.5, 1.0, 5, 10, 50, 100, 500, 1000, 0.1-500, 0.1-100, 1.0-500, 1.0-1000, or 1.0-100 s⁻¹ (1/s), or about 5, 10, 20, 25, 50, 100, 200, or 250 rpm (revolutions per minute), for example.

The aqueous solution component of an aqueous composition in some aspects has no (detectable) dissolved sugars, or about 0.1-1.5, 0.1-1.25, 0.1-1.0, 0.1-0.75, 0.1-0.5, 0.2-0.6, 0.3-0.5, 0.2, 0.3, 0.4, 0.5, or 0.6 wt % dissolved sugars. Such dissolved sugars can include sucrose, fructose, leucrose, and/or soluble gluco-oligosaccharides, for example. The aqueous solution component of an aqueous composition in some aspects can have one or more salts/buffers (e.g., Na+, Cl−, NaCl, phosphate, tris, citrate) (e.g., ≤0.1, 0.5, 1.0, 2.0, or 3.0 wt %), and/or a pH of about 4.0, 4.5, 5.0, 5.5, 6.0, 6.5, 7.0, 7.5, 8.0, 8.5, 9.0, 9.5, 10.0, 10.5, 4.0-10.0, 4.0-9.0, 4.0-8.0, 5.0-10.0, 5.0-9.0, 5.0-8.0, 6.0-10.0, 6.0-9.0, or 6.0-8.0, for example.

The temperature of a composition herein can be about, at least about, or up to about, 0, 5, 10, 15, 20, 25, 30, 35, 40, 45, 50, 55, 60, 65, 70, 75, 80, 85, 90, 95, 100, 105, 110, 115, 120, 125, 130, 5-50, 20-25, 20-30, 20-40, 30-40, 40-130, 40-125, 40-120, 70-130, 70-125, 70-120, 80-130, 80-125, 80-120, 60-100, 60-90, 70-100, 70-90, 75-100, 75-90, or 75-85° C., for example.

A composition herein can, in some aspects, be non-aqueous (e.g., a dry composition). Examples of such embodiments include powders, granules, microcapsules, flakes, or any other form of particulate matter. Other examples include larger compositions such as pellets, bars, kernels, beads, tablets, sticks, or other agglomerates, or ointment or lotion (or any other form herein of a non-aqueous or dry composition). A non-aqueous or dry composition typically has about, or no more than about, 6, 5, 4, 3, 2, 1.5, 1.0, 0.5, 0.25, 0.10, 0.05, or 0.01 wt % water comprised therein. In some aspects (e.g., those directed to a laundry or dish washing detergent), a dry composition herein can be provided in a sachet or pouch.

A composition herein can, in some aspects, be a detergent composition. Examples of such compositions are disclosed herein as detergents for dishwashing and detergents for fabric care.

A composition herein can, in some aspects, comprise one or more salts such as a sodium salt (e.g., NaCl, Na₂SO₄). Other non-limiting examples of salts include those having (i) an aluminum, ammonium, barium, calcium, chromium (II or III), copper (I or II), iron (II or III), hydrogen, lead (II), lithium, magnesium, manganese (II or III), mercury (I or II), potassium, silver, sodium strontium, tin (II or IV), or zinc cation, and (ii) an acetate, borate, bromate, bromide, carbonate, chlorate, chloride, chlorite, chromate, cyanamide, cyanide, dichromate, dihydrogen phosphate, ferricyanide, ferrocyanide, fluoride, hydrogen carbonate, hydrogen phosphate, hydrogen sulfate, hydrogen sulfide, hydrogen sulfite, hydride, hydroxide, hypochlorite, iodate, iodide, nitrate, nitride, nitrite, oxalate, oxide, perchlorate, permanganate, peroxide, phosphate, phosphide, phosphite, silicate, stannate, stannite, sulfate, sulfide, sulfite, tartrate, or thiocyanate anion. Thus, any salt having a cation from (i) above and an anion from (ii) above can be in a composition, for example. A salt can be present in an aqueous composition herein at a wt % of about, or at least about, 0.01, 0.025, 0.05, 0.075, 0.1, 0.25, 0.5, 0.75, 1.0, 1.25, 1.5, 1.75, 2.0, 2.5, 3.0, 3.5, 0.01-3.5, 0.5-3.5, 0.5-2.5, or 0.5-1.5 wt % (such wt % values typically refer to the total concentration of one or more salts), for example.

A composition herein can optionally contain one or more enzymes (active enzymes). Examples of suitable enzymes include proteases, cellulases, hemicellulases, peroxidases, lipolytic enzymes (e.g., metallolipolytic enzymes), xylanases, lipases, phospholipases, esterases (e.g., arylesterase, polyesterase), perhydrolases, cutinases, pectinases, pectate lyases, mannanases, keratinases, reductases, oxidases (e.g., choline oxidase), phenoloxidases, lipoxygenases, ligninases, pullulanases, tannases, pentosanases, malanases, beta-glucanases, arabinosidases, hyaluronidases, chondroitinases, laccases, metalloproteinases, amadoriases, glucoamylases, arabinofuranosidases, phytases, isomerases, transferases, nucleases, and amylases. If an enzyme(s) is included, it may be comprised in a composition herein at about 0.0001-0.1 wt % (e.g., 0.01-0.03 wt %) active enzyme (e.g., calculated as pure enzyme protein), for example. In fabric care or automatic dishwashing applications, an enzyme herein (e.g., any of the above such as cellulase, protease, amylase, and/or lipase) can be present in an aqueous composition in which a fabric or dish is treated (e.g., wash liquor, grey water) at a concentration that is minimally about 0.01-0.1 ppm total enzyme protein, or about 0.1-10 ppb total enzyme protein (e.g., less than 1 ppm), to maximally about 100, 200, 500, 1000, 2000, 3000, 4000, or 5000 ppm total enzyme protein, for example.

An alpha-glucan ester derivative and/or a composition comprising such a derivative is biodegradable in some aspects. Such biodegradability can be, for example, as determined by the Carbon Dioxide Evolution Test Method (OECD Guideline 301B, incorporated herein by reference), to be about, at least about, or at most about, 5%, 10%, 15%, 20%, 25%, 30%, 35%, 40%, 45%, 50%, 55%, 60%, 65%, 70%, 75%, 80%, 85%, 90%, 5-60%, 5-80%, 5-90%, 40-70%, 50-70%, 60-70%, 40-75%, 50-75%, 60-75%, 70-75%, 40-80%, 50-80%, 60-80%, 70-80%, 40-85%, 50-85%, 60-85%, 70-85%, 40-90%, 50-90%, 60-90%, or 70-90%, or any value between 5% and 90%, after 15, 30, 45, 60, 75, or 90 days of testing. It is contemplated that such biodegradability can be about, at least about, or at most about, 10%, 25%, 50%, 75%, 100%, 150%, 200%, 250%, 500%, 750%, or 1000% higher than the biodegradability of an incumbent material.

A composition can comprise one, two, three, four or more different alpha-glucan ester derivatives herein and, optionally, at least one non-derivatized alpha-glucan (e.g., as disclosed herein). For example, a composition can comprise at least one type of alpha-glucan ester derivative and at least one type of alpha-glucan; in some aspects, the latter can be (or can be capable of being) a precursor compound of the former. In some aspects, a non-derivatized alpha-glucan (e.g., precursor compound) is not present.

A composition as presently disclosed can be in the form of a household care (home care) product, personal care product, industrial product, medical product, or pharmaceutical product, for example, such as described in any of U.S. Patent Appl. Publ. Nos. 2018/0022834, 2018/0237816, 2018/0230241, 20180079832, 2016/0311935, 2016/0304629, 2015/0232785, 2015/0368594, 2015/0368595, 2016/0122445, 2019/0202942, or 2019/0309096, or Int. Patent Appl. Publ. No. WO2016/133734, which are all incorporated herein by reference. In some aspects, a composition can comprise at least one component/ingredient of a household care product, personal care product, industrial product, or pharmaceutical product as disclosed in any of the foregoing publications and/or as presently disclosed.

A composition in some aspects is believed to be useful for providing one or more of the following physical properties to a personal care product, pharmaceutical product, household care product, or industrial product: thickening, freeze/thaw stability, lubricity, moisture retention and release, texture, consistency, shape retention, emulsification, binding, suspension, dispersion, gelation, or reduced mineral hardness, for example.

Personal care products herein are not particularly limited and include, for example, skin care compositions, cosmetic compositions, antifungal compositions, and antibacterial compositions. Personal care products herein may be in the form of, for example, lotions, creams, pastes, balms, ointments, pomades, gels, liquids, combinations of these and the like. The personal care products disclosed herein can include at least one active ingredient, if desired. An active ingredient is generally recognized as an ingredient that causes an intended pharmacological effect.

In some aspects, a skin care product can be applied to skin for addressing skin damage related to a lack of moisture. A skin care product may also be used to address the visual appearance of skin (e.g., reduce the appearance of flaky, cracked, and/or red skin) and/or the tactile feel of the skin (e.g., reduce roughness and/or dryness of the skin while improved the softness and subtleness of the skin). A skin care product typically may include at least one active ingredient for the treatment or prevention of skin ailments, providing a cosmetic effect, or for providing a moisturizing benefit to skin, such as zinc oxide, petrolatum, white petrolatum, mineral oil, cod liver oil, lanolin, dimethicone, hard fat, vitamin A, allantoin, calamine, kaolin, glycerin, or colloidal oatmeal, and combinations of these. A skin care product may include one or more natural moisturizing factors such as ceramides, hyaluronic acid, glycerin, squalane, amino acids, cholesterol, fatty acids, triglycerides, phospholipids, glycosphingolipids, urea, linoleic acid, glycosaminoglycans, mucopolysaccharide, sodium lactate, or sodium pyrrolidone carboxylate, for example. Other ingredients that may be included in a skin care product include, without limitation, glycerides, apricot kernel oil, canola oil, squalane, squalene, coconut oil, corn oil, jojoba oil, jojoba wax, lecithin, olive oil, safflower oil, sesame oil, shea butter, soybean oil, sweet almond oil, sunflower oil, tea tree oil, shea butter, palm oil, cholesterol, cholesterol esters, wax esters, fatty acids, and orange oil. A skin care product can be an ointment, lotion, or sanitizer (e.g., hand sanitizer) in some aspects.

A personal care product herein can also be in the form of makeup, lipstick, mascara, rouge, foundation, blush, eyeliner, lip liner, lip gloss, other cosmetics, sunscreen, sun block, nail polish, nail conditioner, bath gel, shower gel, body wash, face wash, lip balm, skin conditioner, cold cream, moisturizer, body spray, soap, body scrub, exfoliant, astringent, scruffing lotion, depilatory, permanent waving solution, antidandruff formulation, antiperspirant composition, deodorant, shaving product, pre-shaving product, after-shaving product, cleanser, skin gel, rinse, dentifrice composition, toothpaste, or mouthwash, for example. An example of a personal care product (e.g., a cleanser, soap, scrub, cosmetic) comprises a carrier or exfoliation agent (e.g., jojoba beads [jojoba ester beads]) (e.g., about 1-10, 3-7, 4-6, or 5 wt %); such an agent may optionally be dispersed within the product.

A personal care product in some aspects can be a hair care product. Examples of hair care products herein include shampoo, hair conditioner (leave-in or rinse-out), cream rinse, hair dye, hair coloring product, hair shine product, hair serum, hair anti-frizz product, hair split-end repair product, mousse (e.g., hair styling mousse), hair spray (e.g., hair styling spray), and styling gel (e.g., hair styling gel). A hair care product can be in the form of a liquid, paste, gel, solid, or powder in some embodiments. A hair care product as presently disclosed typically comprises one or more of the following ingredients, which are generally used to formulate hair care products: anionic surfactants such as polyoxyethylenelauryl ether sodium sulfate; cationic surfactants such as stearyltrimethylammonium chloride and/or distearyltrimethylammonium chloride; nonionic surfactants such as glyceryl monostearate, sorbitan monopalmitate and/or polyoxyethylenecetyl ether; wetting agents such as propylene glycol, 1,3-butylene glycol, glycerin, sorbitol, pyroglutamic acid salts, amino acids and/or trimethylglycine; hydrocarbons such as liquid paraffins, petrolatum, solid paraffins, squalane and/or olefin oligomers; higher alcohols such as stearyl alcohol and/or cetyl alcohol; superfatting agents; antidandruff agents; disinfectants; anti-inflammatory agents; crude drugs; water-soluble polymers such as methyl cellulose, hydroxycellulose and/or partially deacetylated chitin; antiseptics such as paraben; ultra-violet light absorbers; pearling agents; pH adjustors; perfumes; and pigments.

A composition in some aspects can be a hair care composition such as a hair styling or hair setting composition (e.g., hair spray, hair gel or lotion, hair mousse/foam) (e.g., aerosol hair spray, non-aerosol pump-spray, spritze, foam, crème, paste, non-runny gel, mousse, pomade, lacquer, hair wax). A hair styling/setting composition/formulation that can be adapted to include at least one alpha-glucan ester derivative herein can be as disclosed in, for example, US20090074697, WO1999048462, US20130068849, JPH0454116A, U.S. Pat. No. 5,304,368, AU667246B2, U.S. Pat. Nos. 5,413,775, 5,441,728, 5,939,058, JP2001302458A, U.S. Pat. No. 6,346,234, US20020085988, U.S. Pat. No. 7,169,380, US20090060858, US20090326151, US20160008257, WO2020164769, or US20110217256, all of which are incorporated herein by reference. A hair care composition such as a hair styling/setting composition can comprise one or more ingredients/additives as disclosed in any of the foregoing references, and/or one or more of a fragrance/perfume, aroma therapy essence, herb, infusion, antimicrobial, stimulant (e.g., caffeine), essential oil, hair coloring, dying or tinting agent, anti-gray agent, anti-foam agent, sunscreen/UV-blocker (e.g., benzophenone-4), vitamin, antioxidant, surfactant or other wetting agent, mica, silica, metal flakes or other glitter-effect material, conditioning agent (e.g., a volatile or non-volatile silicone fluid), anti-static agent, opacifier, detackifying agent, penetrant, preservative (e.g., phenoxyethanol, ethylhexylglycerin, benzoate, diazolidinyl urea, iodopropynyl butylcarbamate), emollient (e.g., panthenol, isopropyl myristate), rheology-modifying or thickening polymer (e.g., acrylates/methacrylamide copolymer, polyacrylic acid [e.g., CARBOMER]), emulsified oil phase, petrolatum, fatty alcohols, diols and polyols, emulsifier (e.g., PEG-40 hydrogenated castor oil, Oleth-20), humectant (e.g., glycerin, caprylyl glycol), silicone derivative, protein, amino acid (e.g., isoleucine), conditioner, chelant (e.g., EDTA), solvent (e.g., see below), monosaccharide (e.g., dextrose), disaccharide, oligosaccharide, pH-stabilizing compound (e.g., aminomethyl propanol), film former (e.g., acrylates/hydroxyester acrylate copolymer, polyvinylpyrrolidone/vinyl acetate copolymer, triethyl acetate), aerosol propellant (e.g., C₃-C₅ alkane such as propane, isobutane, or n-butane, monoalkyl ether, dialkyl ether such as di (C₁-C₄ alkyl) ether [e.g., dimethyl ether]), and/or any other suitable material herein. An alpha-glucan ester derivative as used in a hair styling/setting composition in some aspects can function as a hair fixing/styling agent (typically non-permanent hair fixing, but durable), and optionally is the only hair fixing agent in the composition. Optional additional hair fixing/styling agents herein include PVP (polyvinylpyrrolidone), octylacrylamide/acrylates/butylaminoethyl methacrylate copolymer, vinyl caprolactam/PVP/dimethylaminoethyl methacrylate copolymer, AMPHOMER, or any film former such as listed above.

The total content of one or more alpha-glucan ester derivatives in a hair care composition such as a hair styling/setting composition herein can be about, at least about, or less than about, 0.5, 1, 2, 3, 4, 5, 6, 7, 8, 9, 10, 11, 12, 13, 14, 15, 0.5-15, 0.5-10, 0.5-5, 0.5-2, 1-15, 1-10, 1-5, 1-2, 2.5-7.5, 3-7, or 4-6 wt %, for example. A hair styling/setting composition can comprise a solvent comprising water and optionally a water-miscible (typically polar) organic compound (e.g., liquid or gas) such as an alcohol (e.g., ethanol, propanol, isopropanol, n-butanol, iso-butanol, tert-butanol), an alkylene glycol alkyl ether, and/or a monoalkyl or dialkyl ether (e.g., dimethyl ether), for example. If an organic compound is included, it can constitute about 10%, 20%, 30%, 40%, 50%, or 60% by weight or volume of the solvent (balance is water), for example. The amount of solvent in a hair styling/setting composition herein can be about 50-90, 60-90, 70-90, 80-90, 50-95, 60-95, 70-95, 80-95, or 90-95 wt %, for example.

An example of a hair styling gel formulation herein can comprise about 90-95 wt % (e.g., ~92 wt %) solvent (e.g., water), 0.3-1.0 wt % (e.g., ~0.5 wt %) thickener (e.g., polyacrylic acid), 0.1-0.3 wt % (e.g., ~0.2 wt %) chelant (e.g., EDTA) (optional), 0.2-1.0 wt % (e.g., ~0.5 wt %) humectant (e.g., glycerin), 0.01-0.05 wt % (e.g., ~0.02 wt %) UV-blocker (e.g., benzophenone-4) (optional), 0.05-0.3 wt % (e.g., ~0.1 wt %) preservative (e.g., diazolidinyl urea) (optional), 0.5-1.2 wt % (e.g., ~0.8 wt %) emulsifier (e.g., Oleth-20), 0.1-0.3 wt % (e.g., ~0.2 wt %) fragrance/perfume (optional), 0.2-1.0 wt % (e.g., ~0.5 wt %) pH-stabilizing compound (e.g., aminomethyl propanol), and 3-7 wt % (e.g., ~5 wt %) alpha-glucan ester derivative herein (e.g., as a hair fixing/styling agent).

An example of a hair styling spray formulation herein can comprise about 0.2-1.0 wt % (e.g., ~0.5 wt %) pH-stabilizing compound (e.g., aminomethyl propanol), 0.1-0.3 wt % (e.g., ~0.2 wt %) fragrance/perfume (optional), 0.05-0.12 wt % (e.g., ~0.08 wt %) surfactant (e.g., ethoxylated dimethicone polyol), 0.05-0.12 wt % (e.g., ~0.08 wt %) conditioner (e.g., cyclomethicone) (optional), 0.05-0.3 wt % (e.g., ~0.2 wt %) preservative (e.g., sodium benzoate) (optional), 15-20 wt % (e.g., ~17 wt %) water, 30-40 wt % (e.g., ~65 wt %) alcohol (e.g., ethanol), 40-60 wt % (e.g., ~45 wt %) propellant (e.g., dimethyl ether, or a ~2:1 mix of dimethyl ether to C₃-C₅ alkane [e.g., mix of propane and isobutane]), and 2-4 wt % (e.g., ~2.75 wt %) alpha-glucan ester derivative herein (e.g., as a hair fixing/styling agent).

Some aspects of the present disclosure regard hair that has been treated with a hair care composition herein (e.g., hair styling/setting composition, shampoo, or conditioner). For example, hair can comprise an alpha-glucan ester derivative on its surface, such as in a film/coating of the hair, and/or adsorbed or otherwise deposited on the hair surface; optionally, one or more other ingredients of a hair care composition herein can also be present. Typically, hair as presently disclosed, such as hair with a coating comprising an alpha-glucan ester, does not exhibit flaking to the naked eye (i.e., little or no noticeable flaking).

Various examples of personal care formulations comprising at least one alpha-glucan ester derivative as presently disclosed are disclosed below (1-3).

(1) A hair conditioner composition comprising: cetyl alcohol (1-3%), isopropyl myristate (1-3%), hydroxyethyl cellulose (Natrosol® 250 HHR, 0.1-1%), alpha-glucan ester derivative (0.1-2%), potassium salt (0.1-0.5%), Germaben® II preservative (0.5%, available from International Specialty Products), and the balance being water.

(2) A hair shampoo composition comprising: 5-20% sodium laureth sulfate (SLES), 1-2 wt % cocamidopropyl betaine, 1-2 wt % sodium chloride, 0.1-2% alpha-glucan ester derivative, preservative (0.1-0.5%), and the balance being water.

(3) A skin lotion composition comprising: 1-5% glycerin, 1-5% glycol stearate, 1-5% stearic acid, 1-5% mineral oil, 0.5-1% acetylated lanolin (Lipolan® 98), 0.1-0.5 cetyl alcohol, 0.2-1% triethanolamine, 0.1-1 wt % Germaben® ∥ preservative, 0.5-2 wt % alpha-glucan ester derivative, and the balance being water.

A pharmaceutical product herein can be in the form of an emulsion, liquid, elixir, gel, suspension, solution, cream, or ointment, for example. Also, a pharmaceutical product herein can be in the form of any of the personal care products disclosed herein, such as an antibacterial or antifungal composition. A pharmaceutical product can further comprise one or more pharmaceutically acceptable carriers, diluents, and/or pharmaceutically acceptable salts. A composition herein can also be used, for example, in capsules, tablets, tablet coatings, and as excipients for medicaments and drugs.

A household and/or industrial product herein can be in the form of drywall tape-joint compounds; mortars; grouts; cement plasters; spray plasters; cement stucco; adhesives; pastes; wall/ceiling texturizers; binders and processing aids for tape casting, extrusion forming, injection molding and ceramics; spray adherents and suspending/dispersing aids for pesticides, herbicides, and fertilizers; fabric care products such as fabric softeners and laundry detergents; hard surface cleaners; air fresheners; polymer emulsions; latex; gels such as water-based gels; surfactant solutions; paints such as water-based paints; protective coatings; adhesives; sealants and caulks; inks such as water-based ink; metal-working fluids; films or coatings; or emulsion-based metal cleaning fluids used in electroplating, phosphatizing, galvanizing and/or general metal cleaning operations, for example. In some aspects, a composition herein is comprised in a fluid as a viscosity modifier and/or friction reducer; such uses include downhole operations/fluids (e.g., in hydraulic fracturing and enhanced oil recovery), for example.

Some aspects herein regard (i) salt water such as seawater, or (ii) an aqueous solution having about 2.0, 2.25, 2.5, 2.75, 3.0, 3.25. 3.5, 3.75, 4.0, 2.5-4.0, 2.75-4.0, 3.0-4.0, 2.5-3.5, 2.75-3.5, 3.0-3.5, 3.0-4.0, or 3.0-3.5 wt % of one or a combination of salts (e.g., including at least NaCl), having at least one aqueous-soluble alpha-glucan ester derivative as presently disclosed. The concentration of an alpha-glucan ester derivative in such water of (i) or (ii) can be about, at least about, or below about, 0.1, 0.2, 0.3, 0.4, 0.5, 0.6, 0.7, 0.8, 0.9, 1.0, 0.1-0.6, 0.1-0.5, 0.1-0.4, 0.1-0.3, or 0.1-0.2 wt %, for example. Despite the relatively high salt concentration in such aqueous compositions, it is contemplated that an alpha-glucan ester derivative in some aspects can remain completely or mostly in solution and provide viscosity. Such a solution of (i) or (ii) as viscosity-modified by an alpha-glucan ester derivative herein can be as it is used within a system that utilizes such a solution (e.g., any herein, such as a downhole operation).

In some aspects, a composition herein can be in the form of, or comprise, a fabric care composition. A fabric care composition can be used for hand wash, machine wash and/or other purposes such as soaking and/or pretreatment of fabrics, for example. A fabric care composition may take the form of, for example, a laundry detergent; fabric conditioner; any wash-, rinse-, or dryer-added product; unit dose or spray. Fabric care compositions in a liquid form may be in the form of an aqueous composition. In other embodiments, a fabric care composition can be in a dry form such as a granular detergent or dryer-added fabric softener sheet. Other non-limiting examples of fabric care compositions can include: granular or powder-form all-purpose or heavy-duty washing agents; liquid, gel or paste-form all-purpose or heavy-duty washing agents; liquid or dry fine-fabric (e.g. delicates) detergents; cleaning auxiliaries such as bleach additives, “stain-stick”, or pre-treatments; substrate-laden products such as dry and wetted wipes, pads, or sponges; sprays and mists; water-soluble unit dose articles. As further examples, a composition herein can be in the form of a liquid, gel, powder, hydrocolloid, aqueous solution, granule, tablet, capsule, bead or pastille, single compartment sachet, multi-compartment sachet, single compartment pouch, or multi-compartment pouch.

A detergent composition herein may be in any useful form, e.g., as powders, granules, pastes, bars, unit dose, or liquid. A liquid detergent may be aqueous, typically containing up to about 70 wt % of water and 0 wt % to about 30 wt % of organic solvent. It may also be in the form of a compact gel type containing only about 30 wt % water.

A detergent composition (e.g., of a fabric care product or any other product herein) typically comprises one or more surfactants, wherein the surfactant is selected from nonionic surfactants, anionic surfactants, cationic surfactants, ampholytic surfactants, zwitterionic surfactants, semi-polar nonionic surfactants and mixtures thereof. In some embodiments, the surfactant is present at a level of from about 0.1% to about 60%, while in alternative embodiments the level is from about 1% to about 50%, while in still further embodiments the level is from about 5% to about 40%, by weight of the detergent composition. A detergent will usually contain 0 wt % to about 50 wt % of an anionic surfactant such as linear alkylbenzenesulfonate (LAS), alpha-olefinsulfonate (AOS), alkyl sulfate (fatty alcohol sulfate) (AS), alcohol ethoxysulfate (AEOS or AES), secondary alkanesulfonates (SAS), alpha-sulfo fatty acid methyl esters, alkyl- or alkenylsuccinic acid, or soap. In addition, a detergent composition may optionally contain 0 wt % to about 40 wt % of a nonionic surfactant such as alcohol ethoxylate (AEO or AE), carboxylated alcohol ethoxylates, nonylphenol ethoxylate, alkylpolyglycoside, alkyldimethylamineoxide, ethoxylated fatty acid monoethanolamide, fatty acid monoethanolamide, or polyhydroxy alkyl fatty acid amide (as described for example in WO92/06154, which is incorporated herein by reference).

A detergent composition herein can optionally comprise one or more detergent builders or builder systems. In some aspects, oxidized alpha-1,3-glucan can be included as a co-builder; oxidized alpha-1,3-glucan compounds for use herein are disclosed in U.S. Patent Appl. Publ. No. 2015/0259439. In some aspects incorporating at least one builder, the cleaning compositions comprise at least about 1%, from about 3% to about 60%, or even from about 5% to about 40%, builder by weight of the composition. Examples of builders include alkali metal, ammonium and alkanolammonium salts of polyphosphates, alkali metal silicates, alkaline earth and alkali metal carbonates, aluminosilicates, polycarboxylate compounds, ether hydroxypolycarboxylates, copolymers of maleic anhydride with ethylene or vinyl methyl ether, 1,3,5-trihydroxy benzene-2,4,6-trisulphonic acid, and carboxymethyloxysuccinic acid, various alkali metal, ammonium and substituted ammonium salts of polyacetic acids such as ethylenediamine tetraacetic acid and nitrilotriacetic acid, as well as polycarboxylates such as mellitic acid, succinic acid, citric acid, oxydisuccinic acid, polymaleic acid, benzene 1,3,5-tricarboxylic acid, carboxymethyloxysuccinic acid, and soluble salts thereof. Additional examples of a detergent builder or complexing agent include zeolite, diphosphate, triphosphate, phosphonate, citrate, nitrilotriacetic acid (NTA), ethylenediaminetetraacetic acid (EDTA), diethylenetriaminepentaacetic acid (DTMPA), alkyl- or alkenylsuccinic acid, soluble silicates or layered silicates (e.g., SKS-6 from Hoechst).

In some embodiments, builders form water-soluble hardness ion complexes (e.g., sequestering builders), such as citrates and polyphosphates (e.g., sodium tripolyphosphate and sodium tripolyphospate hexahydrate, potassium tripolyphosphate, and mixed sodium and potassium tripolyphosphate, etc.). It is contemplated that any suitable builder will find use in the present disclosure, including those known in the art (See, e.g., EP2100949).

In some embodiments, suitable builders can include phosphate builders and non-phosphate builders. In some embodiments, a builder is a phosphate builder. In some embodiments, a builder is a non-phosphate builder. A builder can be used in a level of from 0.1% to 80%, or from 5% to 60%, or from 10% to 50%, by weight of the composition. In some embodiments, the product comprises a mixture of phosphate and non-phosphate builders. Suitable phosphate builders include mono-phosphates, di-phosphates, tri-polyphosphates or oligomeric-polyphosphates, including the alkali metal salts of these compounds, including the sodium salts. In some embodiments, a builder can be sodium tripolyphosphate (STPP). Additionally, the composition can comprise carbonate and/or citrate, preferably citrate that helps to achieve a neutral pH composition. Other suitable non-phosphate builders include homopolymers and copolymers of polycarboxylic acids and their partially or completely neutralized salts, monomeric polycarboxylic acids and hydroxycarboxylic acids and their salts. In some embodiments, salts of the above mentioned compounds include ammonium and/or alkali metal salts, i.e., lithium, sodium, and potassium salts, including sodium salts. Suitable polycarboxylic acids include acyclic, alicyclic, hetero-cyclic and aromatic carboxylic acids, wherein in some embodiments, they can contain at least two carboxyl groups which are in each case separated from one another by, in some instances, no more than two carbon atoms.

A detergent composition herein can comprise at least one chelating agent. Suitable chelating agents include, but are not limited to copper, iron and/or manganese chelating agents and mixtures thereof. In embodiments in which at least one chelating agent is used, the composition comprises from about 0.1% to about 15%, or even from about 3.0% to about 10%, chelating agent by weight of the composition.

A detergent composition herein can comprise at least one deposition aid. Suitable deposition aids include, but are not limited to, polyethylene glycol, polypropylene glycol, polycarboxylate, soil release polymers such as polytelephthalic acid, clays such as kaolinite, montmorillonite, atapulgite, illite, bentonite, halloysite, and mixtures thereof.

A detergent composition herein can comprise one or more dye transfer-inhibiting agents. Suitable polymeric dye transfer-inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof. Additional dye transfer-inhibiting agents include manganese phthalocyanine, peroxidases, polyvinylpyrrolidone polymers, polyamine N-oxide polymers, copolymers of N-vinylpyrrolidone and N-vinylimidazole, polyvinyloxazolidones and polyvinylimidazoles and/or mixtures thereof; chelating agents examples of which include ethylene-diamine-tetraacetic acid (EDTA); diethylene triamine penta methylene phosphonic acid (DTPMP); hydroxy-ethane diphosphonic acid (HEDP); ethylenediamine N,N′-disuccinic acid (EDDS); methyl glycine diacetic acid (MGDA); diethylene triamine penta acetic acid (DTPA); propylene diamine tetraacetic acid (PDT A); 2-hydroxypyridine-N-oxide (HPNO); or methyl glycine diacetic acid (MGDA); glutamic acid N, N-diacetic acid (N,N-dicarboxymethyl glutamic acid tetrasodium salt (GLDA); nitrilotriacetic acid (NTA); 4,5-dihydroxy-m-benzenedisulfonic acid; citric acid and any salts thereof; N-hydroxyethyl ethylenediaminetriacetic acid (HEDTA), triethylenetetraaminehexaacetic acid (TTHA), N-hydroxyethyliminodiacetic acid (HEIDA), dihydroxyethylglycine (DHEG), ethylenediaminetetrapropionic acid (EDTP) and derivatives thereof, which can be used alone or in combination with any of the above. In embodiments in which at least one dye transfer-inhibiting agent is used, a composition herein may comprise from about 0.0001% to about 10%, from about 0.01% to about 5%, or even from about 0.1% to about 3%, by weight of the composition.

A detergent composition herein can comprise silicates. In some of these embodiments, sodium silicates (e.g., sodium disilicate, sodium metasilicate, and/or crystalline phyllosilicates) find use. In some embodiments, silicates are present at a level of from about 1% to about 20% by weight of the composition. In some embodiments, silicates are present at a level of from about 5% to about 15% by weight of the composition.

A detergent composition herein can comprise dispersants. Suitable water-soluble organic materials include, but are not limited to the homo- or co-polymeric acids or their salts, in which the polycarboxylic acid comprises at least two carboxyl radicals separated from each other by not more than two carbon atoms.

A detergent composition herein may additionally comprise one or more enzymes as disclosed above, for example. In some aspects, a detergent composition can comprise one or more enzymes, each at a level from about 0.00001% to about 10% by weight of the composition and the balance of cleaning adjunct materials by weight of composition. In some other aspects, a detergent composition can also comprise each enzyme at a level of about 0.0001% to about 10%, about 0.001% to about 5%, about 0.001% to about 2%, or about 0.005% to about 0.5%, by weight of the composition. Enzymes comprised in a detergent composition herein may be stabilized using conventional stabilizing agents, e.g., a polyol such as propylene glycol or glycerol; a sugar or sugar alcohol; lactic acid; boric acid or a boric acid derivative (e.g., an aromatic borate ester).

A detergent composition in some aspects may comprise one or more other types of polymer in addition to an alpha-glucan ester derivative as disclosed herein. Examples of other types of polymers useful herein include carboxymethyl cellulose (CMC), dextran, poly (vinylpyrrolidone) (PVP), polyethylene glycol (PEG), poly(vinyl alcohol) (PVA), polycarboxylates such as polyacrylates, maleic/acrylic acid copolymers and lauryl methacrylate/acrylic acid copolymers.

A detergent composition herein may contain a bleaching system. For example, a bleaching system can comprise an H₂O₂ source such as perborate or percarbonate, which may be combined with a peracid-forming bleach activator such as tetraacetylethylenediamine (TAED) or nonanoyloxybenzenesulfonate (NOBS). Alternatively, a bleaching system may comprise peroxyacids (e.g., amide, imide, or sulfone type peroxyacids). Alternatively still, a bleaching system can be an enzymatic bleaching system comprising perhydrolase, for example, such as the system described in WO2005/056783.

A detergent composition herein may also contain conventional detergent ingredients such as fabric conditioners, clays, foam boosters, suds suppressors, anti-corrosion agents, soil-suspending agents, anti-soil redeposition agents, dyes, bactericides, tarnish inhibiters, optical brighteners, or perfumes. The pH of a detergent composition herein (measured in aqueous solution at use concentration) is usually neutral or alkaline (e.g., pH of about 7.0 to about 11.0).

Examples of suitable anti-redeposition and/or clay soil removal agents for a fabric care product herein include polyethoxy zwitterionic surfactants, water-soluble copolymers of acrylic or methacrylic acid with acrylic or methacrylic acid-ethylene oxide condensates (e.g., U.S. Pat. No. 3,719,647), cellulose derivatives such as carboxymethylcellulose and hydroxypropylcellulose (e.g., U.S. Pat. Nos. 3,597,416 and 3,523,088), and mixtures comprising nonionic alkyl polyethoxy surfactant, polyethoxy alkyl quaternary cationic surfactant and fatty amide surfactant (e.g., U.S. Pat. No. 4,228,044). Non-limiting examples of other suitable anti-redeposition and clay soil removal agents are disclosed in U.S. Pat. Nos. 4,597,898 and 4,891,160, and International Patent Appl. Publ. No. WO95/32272, all of which are incorporated herein by reference.

Particular forms of detergent compositions that can be adapted for purposes herein are disclosed in, for example, US20090209445A1, US20100081598A1, U.S. Pat. No. 7,001,878B2, EP1504994B1, WO2001085888A2, WO2003089562A1, WO2009098659A1, WO2009098660A1, WO2009112992A1, WO2009124160A1, WO2009152031A1, WO2010059483A1, WO2010088112A1, WO2010090915A1, WO2010135238A1, WO2011094687A1, WO2011094690A1, WO2011127102A1, WO2011163428A1, WO2008000567A1, WO2006045391A1, WO2006007911A1, WO2012027404A1, EP1740690B1, WO2012059336A1, U.S. Pat. No. 6,730,646B1, WO2008087426A1, WO2010116139A1, and WO2012104613A1, all of which are incorporated herein by reference.

Laundry detergent compositions herein can optionally be heavy duty (all purpose) laundry detergent compositions. Exemplary heavy duty laundry detergent compositions comprise a detersive surfactant (10%-40% wt/wt), including an anionic detersive surfactant (selected from a group of linear or branched or random chain, substituted or unsubstituted alkyl sulphates, alkyl sulphonates, alkyl alkoxylated sulphate, alkyl phosphates, alkyl phosphonates, alkyl carboxylates, and/or mixtures thereof), and optionally non-ionic surfactant (selected from a group of linear or branched or random chain, substituted or unsubstituted alkyl alkoxylated alcohol, e.g., C8-C18 alkyl ethoxylated alcohols and/or C6-C12 alkyl phenol alkoxylates), where the weight ratio of anionic detersive surfactant (with a hydrophilic index (Hlc) of from 6.0 to 9) to non-ionic detersive surfactant is greater than 1:1. Suitable detersive surfactants also include cationic detersive surfactants (selected from a group of alkyl pyridinium compounds, alkyl quaternary ammonium compounds, alkyl quaternary phosphonium compounds, alkyl ternary sulphonium compounds, and/or mixtures thereof); zwitterionic and/or amphoteric detersive surfactants (selected from a group of alkanolamine sulpho-betaines); ampholytic surfactants; semi-polar non-ionic surfactants and mixtures thereof.

A detergent herein such as a heavy duty laundry detergent composition may optionally include, a surfactancy boosting polymer consisting of amphiphilic alkoxylated grease cleaning polymers (selected from a group of alkoxylated polymers having branched hydrophilic and hydrophobic properties, such as alkoxylated polyalkylenimines in the range of 0.05 wt %-10 wt %) and/or random graft polymers (typically comprising of hydrophilic backbone comprising monomers selected from the group consisting of: unsaturated C1-C6 carboxylic acids, ethers, alcohols, aldehydes, ketones, esters, sugar units, alkoxy units, maleic anhydride, saturated polyalcohols such as glycerol, and mixtures thereof; and hydrophobic side chain(s) selected from the group consisting of: C4-C25 alkyl group, polypropylene, polybutylene, vinyl ester of a saturated C1-C6 mono-carboxylic acid, C1-C6 alkyl ester of acrylic or methacrylic acid, and mixtures thereof.

A detergent herein such as a heavy duty laundry detergent composition may optionally include additional polymers such as soil release polymers (include anionically end-capped polyesters, for example SRP1, polymers comprising at least one monomer unit selected from saccharide, dicarboxylic acid, polyol and combinations thereof, in random or block configuration, ethylene terephthalate-based polymers and co-polymers thereof in random or block configuration, for example REPEL-O-TEX SF, SF-2 AND SRP6, TEXCARE SRA100, SRA300, SRN100, SRN170, SRN240, SRN300 AND SRN325, MARLOQUEST SL), anti-redeposition agent(s) herein (0.1 wt % to 10 wt %), include carboxylate polymers, such as polymers comprising at least one monomer selected from acrylic acid, maleic acid (or maleic anhydride), fumaric acid, itaconic acid, aconitic acid, mesaconic acid, citraconic acid, methylenemalonic acid, and any mixture thereof, vinylpyrrolidone homopolymer, and/or polyethylene glycol, molecular weight in the range of from 500 to 100,000 Da); and polymeric carboxylate (such as maleate/acrylate random copolymer or polyacrylate homopolymer).

A detergent herein such as a heavy duty laundry detergent composition may optionally further include saturated or unsaturated fatty acids, preferably saturated or unsaturated C12-C24 fatty acids (0 wt % to 10 wt %); deposition aids (examples for which include polysaccharides, cellulosic polymers, poly diallyl dimethyl ammonium halides (DADMAC), and co-polymers of DADMAC with vinyl pyrrolidone, acrylamides, imidazoles, imidazolinium halides, and mixtures thereof, in random or block configuration, cationic guar gum, cationic starch, cationic polyacrylamides, and mixtures thereof.

A detergent herein such as a heavy duty laundry detergent composition may optionally further include at least one dye transfer-inhibiting agent, examples of which are described above.

A detergent herein such as a heavy duty laundry detergent composition may optionally include silicone or fatty-acid based suds suppressors; hueing dyes, calcium and magnesium cations, visual signaling ingredients, anti-foam (0.001 wt % to about 4.0 wt %), and/or a structurant/thickener (0.01 wt % to 5 wt %) selected from the group consisting of diglycerides and triglycerides, ethylene glycol distearate, microcrystalline cellulose, microfiber cellulose, biopolymers, xanthan gum, gellan gum, and mixtures thereof. A structurant can also be referred to as a structural agent.

A detergent herein can be in the form of a heavy duty dry/solid laundry detergent composition, for example. Such a detergent may include: (i) a detersive surfactant, such as any anionic detersive surfactant disclosed herein, any non-ionic detersive surfactant disclosed herein, any cationic detersive surfactant disclosed herein, any zwitterionic and/or amphoteric detersive surfactant disclosed herein, any ampholytic surfactant, any semi-polar non-ionic surfactant, and mixtures thereof; (ii) a builder, such as any phosphate-free builder (e.g., zeolite builders in the range of 0 wt % to less than 10 wt %), any phosphate builder (e.g., sodium tri-polyphosphate in the range of 0 wt % to less than 10 wt %), citric acid, citrate salts and nitrilotriacetic acid, any silicate salt (e.g., sodium or potassium silicate or sodium meta-silicate in the range of 0 wt % to less than 10 wt %); any carbonate salt (e.g., sodium carbonate and/or sodium bicarbonate in the range of 0 wt % to less than 80 wt %), and mixtures thereof; (iii) a bleaching agent, such as any photobleach (e.g., sulfonated zinc phthalocyanines, sulfonated aluminum phthalocyanines, xanthenes dyes, and mixtures thereof), any hydrophobic or hydrophilic bleach activator (e.g., dodecanoyl oxybenzene sulfonate, decanoyl oxybenzene sulfonate, decanoyl oxybenzoic acid or salts thereof, 3,5,5-trimethy hexanoyl oxybenzene sulfonate, tetraacetyl ethylene diamine-TAED, nonanoyloxybenzene sulfonate-NOBS, nitrile quats, and mixtures thereof), any source of hydrogen peroxide (e.g., inorganic perhydrate salts, examples of which include mono or tetra hydrate sodium salt of perborate, percarbonate, persulfate, perphosphate, or persilicate), any preformed hydrophilic and/or hydrophobic peracids (e.g., percarboxylic acids and salts, percarbonic acids and salts, perimidic acids and salts, peroxymonosulfuric acids and salts, and mixtures thereof); and/or (iv) any other components such as a bleach catalyst (e.g., imine bleach boosters examples of which include iminium cations and polyions, iminium zwitterions, modified amines, modified amine oxides, N-sulphonyl imines, N-phosphonyl imines, N-acyl imines, thiadiazole dioxides, perfluoroimines, cyclic sugar ketones, and mixtures thereof), and a metal-containing bleach catalyst (e.g., copper, iron, titanium, ruthenium, tungsten, molybdenum, or manganese cations along with an auxiliary metal cations such as zinc or aluminum and a sequestrate such as EDTA, ethylenediaminetetra (methylenephosphonic acid).

A detergent herein such as that for fabric care (e.g., laundry) can be comprised in a unit dose (e.g., sachet or pouch), for example. A unit dose form can comprise a water-soluble outer film that completely envelopes a liquid or solid detergent composition. A unit dose can comprise a single compartment, or at least two, three, or more (multiple) compartments. Multiple compartments can be arranged in a superposed orientation or a side-by-side orientation. A unit dose herein is typically a closed structure of any form/shape suitable for holding and protecting its contents without allowing contents release prior to contact with water.

Compositions disclosed herein can be in the form of, or comprise, a dishwashing detergent composition, for example. Examples of dishwashing detergents include automatic dishwashing detergents (typically used in dishwasher machines) and hand-washing dish detergents. A dishwashing detergent composition can be in any dry or liquid/aqueous form as disclosed herein, for example. Components that may be included in some aspects of a dishwashing detergent composition include, for example, one or more of a phosphate; oxygen- or chlorine-based bleaching agent; non-ionic surfactant; alkaline salt (e.g., metasilicates, alkali metal hydroxides, sodium carbonate); any active enzyme disclosed herein; anti-corrosion agent (e.g., sodium silicate); anti-foaming agent; additives to slow down the removal of glaze and patterns from ceramics; perfume; anti-caking agent (in granular detergent); starch (in tablet-based detergents); gelling agent (in liquid/gel based detergents); and/or sand (powdered detergents).

Dishwashing detergents such as an automatic dishwasher detergent or liquid dishwashing detergent can comprise (i) a non-ionic surfactant, including any ethoxylated non-ionic surfactant, alcohol alkoxylated surfactant, epoxy-capped poly (oxyalkylated) alcohol, or amine oxide surfactant present in an amount from 0 to 10 wt %; (ii) a builder, in the range of about 5-60 wt %, including any phosphate builder (e.g., mono-phosphates, di-phosphates, tri-polyphosphates, other oligomeric-polyphosphates, sodium tripolyphosphate-STPP), any phosphate-free builder (e.g., amino acid-based compounds including methyl-glycine-diacetic acid [MGDA] and salts or derivatives thereof, glutamic-N, N-diacetic acid [GLDA] and salts or derivatives thereof, iminodisuccinic acid (IDS) and salts or derivatives thereof, carboxy methyl inulin and salts or derivatives thereof, nitrilotriacetic acid [NTA], diethylene triamine penta acetic acid [DTPA], B-alaninediacetic acid [B-ADA] and salts thereof), homopolymers and copolymers of poly-carboxylic acids and partially or completely neutralized salts thereof, monomeric polycarboxylic acids and hydroxycarboxylic acids and salts thereof in the range of 0.5 wt % to 50 wt %, or sulfonated/carboxylated polymers in the range of about 0.1 wt % to about 50 wt %; (iii) a drying aid in the range of about 0.1 wt % to about 10 wt % (e.g., polyesters, especially anionic polyesters, optionally together with further monomers with 3 to 6 functionalities-typically acid, alcohol or ester functionalities which are conducive to polycondensation, polycarbonate-, polyurethane- and/or polyurea-polyorganosiloxane compounds or precursor compounds thereof, particularly of the reactive cyclic carbonate and urea type); (iv) a silicate in the range from about 1 wt % to about 20 wt % (e.g., sodium or potassium silicates such as sodium disilicate, sodium meta-silicate and crystalline phyllosilicates); (v) an inorganic bleach (e.g., perhydrate salts such as perborate, percarbonate, perphosphate, persulfate and persilicate salts) and/or an organic bleach (e.g., organic peroxyacids such as diacyl- and tetraacylperoxides, especially diperoxydodecanedioic acid, diperoxytetradecanedioic acid, and diperoxyhexadecanedioic acid); (vi) a bleach activator (e.g., organic peracid precursors in the range from about 0.1 wt % to about 10 wt %) and/or bleach catalyst (e.g., manganese triazacyclononane and related complexes; Co, Cu, Mn, and Fe bispyridylamine and related complexes; and pentamine acetate cobalt (III) and related complexes); (vii) a metal care agent in the range from about 0.1 wt % to 5 wt % (e.g., benzatriazoles, metal salts and complexes, and/or silicates); (viii) a glass corrosion inhibitor in the range of about 0.1 wt % to 5 wt % (e.g., a salt and/or complex of magnesium, zinc, or bismuth); and/or (ix) any active enzyme disclosed herein in the range from about 0.01 to 5.0 mg of active enzyme per gram of automatic dishwashing detergent composition, and an enzyme stabilizer component (e.g., oligosaccharides, polysaccharides, and inorganic divalent metal salts). In some aspects, a dishwashing detergent ingredient or entire composition (but adapted accordingly to comprise an alpha-glucan ester derivative herein) can be as disclosed in U.S. Pat. Nos. 8,575,083 or 9,796,951, or U.S. Pat. Appl. Publ. No. 2017/0044468, which are each incorporated herein by reference.

A detergent herein such as that for dish care can be comprised in a unit dose (e.g., sachet or pouch) (e.g., water-soluble unit dose article), for example, and can be as described above for a fabric care detergent, but rather comprise a suitable dish detergent composition.

It is believed that numerous commercially available detergent formulations can be adapted to include an alpha-glucan ester derivative as disclosed herein. Examples of commercially available detergent formulations include PUREX® ULTRAPACKS (Henkel), FINISH® QUANTUM (Reckitt Benckiser), CLOROX™ 2 PACKS (Clorox), OXICLEAN MAX FORCE POWER PAKS (Church & Dwight), TIDER STAIN RELEASE, CASCADE® ACTIONPACS, and TIDER PODS™ (Procter & Gamble).

Compositions disclosed herein can be in the form of, or comprise, an oral care composition, for example. Examples of oral care compositions include dentifrices, toothpaste, mouth wash, mouth rinse, chewing gum, and edible strips that provide some form of oral care (e.g., treatment or prevention of cavities [dental caries], gingivitis, plaque, tartar, and/or periodontal disease). An oral care composition can also be for treating an “oral surface”, which encompasses any soft or hard surface within the oral cavity including surfaces of the tongue, hard and soft palate, buccal mucosa, gums and dental surfaces. A “dental surface” herein is a surface of a natural tooth or a hard surface of artificial dentition including a crown, cap, filling, bridge, denture, or dental implant, for example.

An oral care composition herein can comprise about 0.01-15.0 wt % (e.g., ~0.1-10 wt % or ~0.1-5.0 wt %, ~0.1-2.0 wt %) of an alpha-glucan ester derivative as disclosed herein, for example. An alpha-glucan ester derivative comprised in an oral care composition can sometimes be provided therein as a thickening agent and/or dispersion agent, which may be useful to impart a desired consistency and/or mouth feel to the composition. One or more other thickening or dispersion agents can also be provided in an oral care composition herein, such as a carboxyvinyl polymer, carrageenan (e.g., L-carrageenan), natural gum (e.g., karaya, xanthan, gum arabic, tragacanth), colloidal magnesium aluminum silicate, or colloidal silica, for example.

An oral care composition herein may be a toothpaste or other dentifrice, for example. Such compositions, as well as any other oral care composition herein, can additionally comprise, without limitation, one or more of an anticaries agent, antimicrobial or antibacterial agent, anticalculus or tartar control agent, surfactant, abrasive, pH-modifying agent, foam modulator, humectant, flavorant, sweetener, pigment/colorant, whitening agent, and/or other suitable components. Examples of oral care compositions to which an alpha-glucan ester derivative herein can be added are disclosed in U.S. Patent Appl. Publ. Nos. 2006/0134025, 2002/0022006 and 2008/0057007, which are incorporated herein by reference.

An anticaries agent herein can be an orally acceptable source of fluoride ions. Suitable sources of fluoride ions include fluoride, monofluorophosphate and fluorosilicate salts as well as amine fluorides, including olaflur (N′-octadecyltrimethylendiamine-N, N,N′-tris (2-ethanol)-dihydrofluoride), for example. An anticaries agent can be present in an amount providing a total of about 100-20000 ppm, about 200-5000 ppm, or about 500-2500 ppm, fluoride ions to the composition, for example. In oral care compositions in which sodium fluoride is the sole source of fluoride ions, an amount of about 0.01-5.0 wt %, about 0.05-1.0 wt %, or about 0.1-0.5 wt %, sodium fluoride can be present in the composition, for example.

An antimicrobial or antibacterial agent suitable for use in an oral care composition herein includes, for example, phenolic compounds (e.g., 4-allylcatechol; p-hydroxybenzoic acid esters such as benzylparaben, butylparaben, ethylparaben, methylparaben and propylparaben; 2-benzylphenol; butylated hydroxyanisole; butylated hydroxytoluene; capsaicin; carvacrol; creosol; eugenol; guaiacol; halogenated bisphenolics such as hexachlorophene and bromochlorophene; 4-hexylresorcinol; 8-hydroxyquinoline and salts thereof; salicylic acid esters such as menthyl salicylate, methyl salicylate and phenyl salicylate; phenol; pyrocatechol; salicylanilide; thymol; halogenated diphenylether compounds such as triclosan and triclosan monophosphate), copper (II) compounds (e.g., copper (II) chloride, fluoride, sulfate and hydroxide), zinc ion sources (e.g., zinc acetate, citrate, gluconate, glycinate, oxide, and sulfate), phthalic acid and salts thereof (e.g., magnesium monopotassium phthalate), hexetidine, octenidine, sanguinarine, benzalkonium chloride, domiphen bromide, alkylpyridinium chlorides (e.g. cetylpyridinium chloride, tetradecylpyridinium chloride, N-tetradecyl-4-ethylpyridinium chloride), iodine, sulfonamides, bisbiguanides (e.g., alexidine, chlorhexidine, chlorhexidine digluconate), piperidino derivatives (e.g., delmopinol, octapinol), magnolia extract, grapeseed extract, rosemary extract, menthol, geraniol, citral, eucalyptol, antibiotics (e.g., augmentin, amoxicillin, tetracycline, doxycycline, minocycline, metronidazole, neomycin, kanamycin, clindamycin), and/or any antibacterial agents disclosed in U.S. Pat. No. 5,776,435, which is incorporated herein by reference. One or more antimicrobial agents can optionally be present at about 0.01-10 wt % (e.g., 0.1-3 wt %), for example, in the disclosed oral care composition.

An anticalculus or tartar control agent suitable for use in an oral care composition herein includes, for example, phosphates and polyphosphates (e.g., pyrophosphates), polyaminopropanesulfonic acid (AMPS), zinc citrate trihydrate, polypeptides (e.g., polyaspartic and polyglutamic acids), polyolefin sulfonates, polyolefin phosphates, diphosphonates (e.g.,azacycloalkane-2,2-diphosphonates such as azacycloheptane-2,2-diphosphonic acid), N-methyl azacyclopentane-2,3-diphosphonic acid, ethane-1-hydroxy-1,1-diphosphonic acid (EHDP), ethane-1-amino-1,1-diphosphonate, and/or phosphonoalkane carboxylic acids and salts thereof (e.g., their alkali metal and ammonium salts). Useful inorganic phosphate and polyphosphate salts include, for example, monobasic, dibasic and tribasic sodium phosphates, sodium tripolyphosphate, tetrapolyphosphate, mono-, di-, tri- and tetra-sodium pyrophosphates, disodium dihydrogen pyrophosphate, sodium trimetaphosphate, sodium hexametaphosphate, or any of these in which sodium is replaced by potassium or ammonium. Other useful anticalculus agents in certain embodiments include anionic polycarboxylate polymers (e.g., polymers or copolymers of acrylic acid, methacrylic, and maleic anhydride such as polyvinyl methyl ether/maleic anhydride copolymers). Still other useful anticalculus agents include sequestering agents such as hydroxycarboxylic acids (e.g., citric, fumaric, malic, glutaric and oxalic acids and salts thereof) and aminopolycarboxylic acids (e.g., EDTA). One or more anticalculus or tartar control agents can optionally be present at about 0.01-50 wt % (e.g., about 0.05-25 wt % or about 0.1-15 wt %), for example, in the disclosed oral care composition.

A surfactant suitable for use in an oral care composition herein may be anionic, non-ionic, or amphoteric, for example. Suitable anionic surfactants include, without limitation, water-soluble salts of C8-20 alkyl sulfates, sulfonated monoglycerides of C8-20 fatty acids, sarcosinates, and taurates. Examples of anionic surfactants include sodium lauryl sulfate, sodium coconut monoglyceride sulfonate, sodium lauryl sarcosinate, sodium lauryl isoethionate, sodium laureth carboxylate and sodium dodecyl benzenesulfonate. Suitable non-ionic surfactants include, without limitation, poloxamers, polyoxyethylene sorbitan esters, fatty alcohol ethoxylates, alkylphenol ethoxylates, tertiary amine oxides, tertiary phosphine oxides, and dialkyl sulfoxides. Suitable amphoteric surfactants include, without limitation, derivatives of C8-20 aliphatic secondary and tertiary amines having an anionic group such as a carboxylate, sulfate, sulfonate, phosphate or phosphonate. An example of a suitable amphoteric surfactant is cocoamidopropyl betaine. One or more surfactants are optionally present in a total amount of about 0.01-10 wt % (e.g., about 0.05-5.0 wt % or about 0.1-2.0 wt %), for example, in the disclosed oral care composition.

An abrasive suitable for use in an oral care composition herein may include, for example, silica (e.g., silica gel, hydrated silica, precipitated silica), alumina, insoluble phosphates, calcium carbonate, and resinous abrasives (e.g., a urea-formaldehyde condensation product). Examples of insoluble phosphates useful as abrasives herein are orthophosphates, polymetaphosphates and pyrophosphates, and include dicalcium orthophosphate dihydrate, calcium pyrophosphate, beta-calcium pyrophosphate, tricalcium phosphate, calcium polymetaphosphate and insoluble sodium polymetaphosphate. One or more abrasives are optionally present in a total amount of about 5-70 wt % (e.g., about 10-56 wt % or about 15-30 wt %), for example, in the disclosed oral care composition. The average particle size of an abrasive in certain embodiments is about 0.1-30 microns (e.g., about 1-20 microns or about 5-15 microns).

An oral care composition in certain embodiments may comprise at least one pH-modifying agent. Such agents may be selected to acidify, make more basic, or buffer the pH of a composition to a pH range of about 2-10 (e.g., pH ranging from about 2-8, 3-9, 4-8, 5-7, 6-10, or 7-9). Examples of pH-modifying agents useful herein include, without limitation, carboxylic, phosphoric and sulfonic acids; acid salts (e.g., monosodium citrate, disodium citrate, monosodium malate); alkali metal hydroxides (e.g. sodium hydroxide, carbonates such as sodium carbonate, bicarbonates, sesquicarbonates); borates; silicates; phosphates (e.g., monosodium phosphate, trisodium phosphate, pyrophosphate salts); and imidazole.

A foam modulator suitable for use in an oral care composition herein may be a polyethylene glycol (PEG), for example. High molecular weight PEGs are suitable, including those having an average molecular weight of about 200000-7000000 (e.g., about 500000-5000000 or about 1000000-2500000), for example. One or more PEGs are optionally present in a total amount of about 0.1-10 wt % (e.g. about 0.2-5.0 wt % or about 0.25-2.0 wt %), for example, in the disclosed oral care composition.

An oral care composition in certain embodiments may comprise at least one humectant. A humectant in certain embodiments may be a polyhydric alcohol such as glycerin, sorbitol, xylitol, or a low molecular weight PEG. Most suitable humectants also may function as a sweetener herein. One or more humectants are optionally present in a total amount of about 1.0-70 wt % (e.g., about 1.0-50 wt %, about 2-25 wt %, or about 5-15 wt %), for example, in the disclosed oral care composition.

A natural or artificial sweetener may optionally be comprised in an oral care composition herein. Examples of suitable sweeteners include dextrose, sucrose, maltose, dextrin, invert sugar, mannose, xylose, ribose, fructose, levulose, galactose, corn syrup (e.g., high fructose corn syrup or corn syrup solids), partially hydrolyzed starch, hydrogenated starch hydrolysate, sorbitol, mannitol, xylitol, maltitol, isomalt, aspartame, neotame, saccharin and salts thereof, dipeptide-based intense sweeteners, and cyclamates. One or more sweeteners are optionally present in a total amount of about 0.005-5.0 wt %, for example, in the disclosed oral care composition.

A natural or artificial flavorant may optionally be comprised in an oral care composition herein. Examples of suitable flavorants include vanillin; sage; marjoram; parsley oil; spearmint oil; cinnamon oil; oil of wintergreen (methylsalicylate); peppermint oil; clove oil; bay oil; anise oil; eucalyptus oil; citrus oils; fruit oils; essences such as those derived from lemon, orange, lime, grapefruit, apricot, banana, grape, apple, strawberry, cherry, or pineapple; bean- and nut-derived flavors such as coffee, cocoa, cola, peanut, or almond; and adsorbed and encapsulated flavorants. Also encompassed within flavorants herein are ingredients that provide fragrance and/or other sensory effect in the mouth, including cooling or warming effects. Such ingredients include, without limitation, menthol, menthyl acetate, menthyl lactate, camphor, eucalyptus oil, eucalyptol, anethole, eugenol, cassia, oxanone, Irisone®, propenyl guaiethol, thymol, linalool, benzaldehyde, cinnamaldehyde, N-ethyl-p-menthan-3-carboxamine, N,2,3-trimethyl-2-isopropylbutanamide, 3-(1-menthoxy)-propane-1,2-diol, cinnamaldehyde glycerol acetal (CGA), and menthone glycerol acetal (MGA). One or more flavorants are optionally present in a total amount of about 0.01-5.0 wt % (e.g., about 0.1-2.5 wt %), for example, in the disclosed oral care composition.

An oral care composition in certain embodiments may comprise at least one bicarbonate salt. Any orally acceptable bicarbonate can be used, including alkali metal bicarbonates such as sodium or potassium bicarbonate, and ammonium bicarbonate, for example. One or more bicarbonate salts are optionally present in a total amount of about 0.1-50 wt % (e.g., about 1-20 wt %), for example, in the disclosed oral care composition.

An oral care composition in certain embodiments may comprise at least one whitening agent and/or colorant. A suitable whitening agent is a peroxide compound such as any of those disclosed in U.S. Pat. No. 8,540,971, which is incorporated herein by reference. Suitable colorants herein include pigments, dyes, lakes and agents imparting a particular luster or reflectivity such as pearling agents, for example. Specific examples of colorants useful herein include talc; mica; magnesium carbonate; calcium carbonate; magnesium silicate; magnesium aluminum silicate; silica; titanium dioxide; zinc oxide; red, yellow, brown and black iron oxides; ferric ammonium ferrocyanide; manganese violet; ultramarine; titaniated mica; and bismuth oxychloride. One or more colorants are optionally present in a total amount of about 0.001-20 wt % (e.g., about 0.01-10 wt % or about 0.1-5.0 wt %), for example, in the disclosed oral care composition.

Additional components that can optionally be included in an oral composition herein include one or more enzymes (above), vitamins, and anti-adhesion agents, for example. Examples of vitamins useful herein include vitamin C, vitamin E, vitamin B5, and folic acid. Examples of suitable anti-adhesion agents include solbrol, ficin, and quorum-sensing inhibitors.

Additional examples of personal care, household care, and other products and ingredients herein can be any as disclosed in U.S. Pat. No. 8,796,196, which is incorporated herein by reference. Examples of personal care, household care, and other products and ingredients herein include perfumes, fragrances, air odor-reducing agents, insect repellents and insecticides, bubble-generating agents such as surfactants, pet deodorizers, pet insecticides, pet shampoos, disinfecting agents, hard surface (e.g., floor, tub/shower, sink, toilet bowl, door handle/panel, glass/window, car/automobile exterior or interior) treatment agents (e.g., cleaning, disinfecting, and/or coating agents), wipes and other non-woven materials, colorants, preservatives, antioxidants, emulsifiers, emollients, oils, medicaments, flavors, and suspending agents.

The present disclosure also concerns a method of treating a material. This method comprises contacting a material with an aqueous composition comprising at least one alpha-glucan ester derivative as disclosed herein.

A material contacted with an aqueous composition in a contacting method herein can comprise a fabric in some aspects. A fabric herein can comprise natural fibers, synthetic fibers, semi-synthetic fibers, or any combination thereof. A semi-synthetic fiber herein is produced using naturally occurring material that has been chemically derivatized, an example of which is rayon. Non-limiting examples of fabric types herein include fabrics made of (i) cellulosic fibers such as cotton (e.g., broadcloth, canvas, chambray, chenille, chintz, corduroy, cretonne, damask, denim, flannel, gingham, jacquard, knit, matelassé, oxford, percale, poplin, plissé, sateen, seersucker, sheers, terry cloth, twill, velvet), rayon (e.g., viscose, modal, lyocell), linen, and Tencel®; (ii) proteinaceous fibers such as silk, wool and related mammalian fibers; (iii) synthetic fibers such as polyester, acrylic, nylon, and the like; (iv) long vegetable fibers from jute, flax, ramie, coir, kapok, sisal, henequen, abaca, hemp and sunn; and (v) any combination of a fabric of (i)-(iv). Fabric comprising a combination of fiber types (e.g., natural and synthetic) include those with both a cotton fiber and polyester, for example. Materials/articles containing one or more fabrics herein include, for example, clothing, curtains, drapes, upholstery, carpeting, bed linens, bath linens, tablecloths, sleeping bags, tents, car interiors, etc. Other materials comprising natural and/or synthetic fibers include, for example, non-woven fabrics, paddings, paper, and foams.

An aqueous composition that is contacted with a fabric can be, for example, a fabric care composition (e.g., laundry detergent, fabric softener). Thus, a treatment method in certain embodiments can be considered a fabric care method or laundry method if employing a fabric care composition therein. A fabric care composition herein is contemplated to effect one or more of the following fabric care benefits (i.e., surface substantive effects): wrinkle removal, wrinkle reduction, wrinkle resistance, fabric wear reduction, fabric wear resistance, fabric pilling reduction, extended fabric life, fabric color maintenance, fabric color fading reduction, reduced dye transfer, fabric color restoration, fabric soiling reduction, fabric soil release, fabric shape retention, fabric smoothness enhancement, anti-redeposition of soil on fabric, anti-greying of laundry, improved fabric hand/handle, and/or fabric shrinkage reduction.

Examples of conditions (e.g., time, temperature, wash/rinse volumes) for conducting a fabric care method or laundry method herein are disclosed in WO1997/003161 and U.S. Pat. Nos. 4,794,661, 4,580,421 and 5,945,394, which are incorporated herein by reference. In other examples, a material comprising fabric can be contacted with an aqueous composition herein: (i) for at least about 5, 10, 20, 30, 40, 50, 60, 70, 80, 90, 100, 110, or 120 minutes; (ii) at a temperature of at least about 10, 15, 20, 25, 30, 35, 40, 45, 50, 55, 60, 65, 70, 75, 80, 85, 90, or 95° C. (e.g., for laundry wash or rinse: a “cold” temperature of about 15-30° C., a “warm” temperature of about 30-50° C., a “hot” temperature of about 50-95° C.); (iii) at a pH of about 2, 3, 4, 5, 6, 7, 8, 9, 10, 11, or 12 (e.g., pH range of about 2-12, or about 3-11); (iv) at a salt (e.g., NaCl) concentration of at least about 0.5, 1.0, 1.5, 2.0, 2.5, 3.0, 3.5, or 4.0 wt %; or any combination of (i)-(iv).

The contacting step in a fabric care method or laundry method can comprise any of washing, soaking, and/or rinsing steps, for example. Contacting a material or fabric in still further embodiments can be performed by any means known in the art, such as dissolving, mixing, shaking, spraying, treating, immersing, flushing, pouring on or in, combining, painting, coating, applying, affixing to, and/or communicating an effective amount of an alpha-glucan ester derivative herein with the fabric or material. In still further embodiments, contacting may be used to treat a fabric to provide a surface substantive effect. As used herein, the term “fabric hand” or “handle” refers to a person's tactile sensory response towards fabric which may be physical, physiological, psychological, social or any combination thereof. In one embodiment, the fabric hand may be measured using a PhabrOmeter® System for measuring relative hand value (available from Nu Cybertek, Inc. Davis, CA) (American Association of Textile Chemists and Colorists [AATCC test method “202-2012, Relative Hand Value of Textiles: Instrumental Method”]).

In some aspects of treating a material comprising fabric, an alpha-glucan ester derivative of the aqueous composition adsorbs to the fabric. This feature is believed to render an alpha-glucan ester derivative herein useful as an anti-redeposition agent and/or anti-greying agent in fabric care compositions (in addition to its viscosity-modifying effect, e.g.). An anti-redeposition agent or anti-greying agent herein helps keep soil from redepositing onto clothing in wash water after the soil has been removed. It is further contemplated that adsorption of an alpha-glucan ester derivative herein to a fabric enhances mechanical properties of the fabric in some aspects.

Adsorption of an alpha-glucan ester derivative to a fabric herein can be measured using a colorimetric technique (e.g., Dubois et al., 1956, Anal. Chem. 28:350-356; Zemljič et al., 2006, Lenzinger Berichte 85:68-76; both incorporated herein by reference), for example, or any other method known in the art.

Other materials that can be contacted in the above treatment method include surfaces that can be treated with a dish detergent (e.g., automatic dishwashing detergent or hand dish detergent). Examples of such materials include surfaces of dishes, glasses, pots, pans, baking dishes, utensils and flatware made from ceramic material, china, metal, glass, plastic (e.g., polyethylene, polypropylene, polystyrene, melamine, etc.) and wood (collectively referred to herein as “tableware”). Thus, the treatment method in certain embodiments can be considered a dishwashing method or tableware washing method, for example. Examples of conditions (e.g., time, temperature, wash volume) for conducting a dishwashing or tableware washing method herein are disclosed herein and in U.S. Pat. No. 8,575,083 and U.S. Pat. Appl. Publ. No. 2017/0044468, which are incorporated herein by reference. In some aspects, a tableware article can be contacted with an aqueous composition herein under a suitable set of conditions such as any of those disclosed above with regard to contacting a fabric-comprising material.

Other materials that can be contacted in the above treatment method include oral surfaces such as any soft or hard surface within the oral cavity including surfaces of the tongue, hard and soft palate, buccal mucosa, gums and dental surfaces (e.g., natural tooth or a hard surface of artificial dentition such as a crown, cap, filling, bridge, denture, or dental implant). Thus, a treatment method in certain embodiments can be considered an oral care method or dental care method, for example. Conditions (e.g., time, temperature) for contacting an oral surface with an aqueous composition herein should be suitable for the intended purpose of making such contact. Other surfaces that can be contacted in a treatment method also include a surface of the integumentary system such as skin, hair or nails (i.e., any keratin-comprising tissue or material).

Thus, some aspects of the present disclosure concern material (e.g., fabric, or a fiber-comprising product as disclosed herein, or any other material herein such as hair, skin, or other keratin-comprising material) that comprises an alpha-glucan ester derivative herein. Such material can be produced following a material treatment method as disclosed herein, for example. A material may comprise an alpha-glucan ester derivative in some aspects if the alpha-glucan ester derivative is adsorbed to, or otherwise in contact with (e.g., alpha-glucan ester comprised in a coating of the material), the surface of the material.

Some aspects of a method of treating a material herein further comprise a drying step, in which a material is dried after being contacted with the aqueous composition. A drying step can be performed directly after the contacting step, or following one or more additional steps that might follow the contacting step (e.g., drying of fabric, tableware, or hair after being rinsed, in water for example, following a wash in an aqueous composition herein). Drying can be performed by any of several means known in the art, such as air drying (e.g., ~20-25° C.), or at a temperature of at least about 30, 40, 50, 60, 70, 80, 90, 100, 120, 140, 160, 170, 175, 180, or 200° C., for example. A material that has been dried herein typically has less than 3, 2, 1, 0.5, or 0.1 wt % water comprised therein.

An aqueous composition used in a treatment method herein can be any aqueous composition disclosed herein. Examples of aqueous compositions include detergents (e.g., laundry detergent or dish detergent), fabric softeners, water-containing dentifrices such as toothpaste, and hair care products such as hair styling, hair cleaning, or hair conditioning products.

Some aspects herein regard a method of styling hair. Such a method can comprise, for example, at least steps (a) and (b), or steps (c) or (d), as follows:
(a) contacting (e.g., coating) hair with a composition comprising an alpha-glucan ester derivative herein, thereby providing treated hair (or coated hair), and
(b) putting the treated hair (or the coated hair) into a desired form; or
(c) putting hair into a desired form, and
(d) contacting (e.g., coating) the hair of step (c) with a composition comprising an alpha-glucan ester derivative herein, thereby providing treated hair (or coated hair); and
(e) optionally, removing solvent, if present, that was used to deliver the alpha-glucan ester derivative to the hair in step (a) or (d).

Such a method can optionally be characterized as a hair styling method. Contacting in a hair styling method can be performed, for example, by applying/treating hair with a hairstyling composition herein (e.g., gel, mouse, spray) comprising at least one alpha-glucan ester derivative. Hair to be treated in a hair styling method, particularly in steps (a) or (d), typically can be wet or dry. Step (e) of removing solvent can be performed by drying, for example, such as by a drying method disclosed herein (e.g., air drying or blow drying, with either room temperature or heated air). Drying can be done with (or without) agitation of the treated hair, such as by combing or brushing while drying. Optionally, a styling method herein can comprise, after step (b) or step (d) (but before optional step [e]), a step of applying steam to the treated hair. Step (b) or (c) of putting hair into a desired form can be performed in some aspects by straightening, curling, or otherwise putting the hair into a form that is different from the form the hair was in as it existed before step (a), (b), or (c). Hair that is styled by a styling method herein can hold, optionally without the need to apply any device and/or further material to the styled hair (i.e., while in a free-standing state), the desired form for a period of at least 1, 2, 3, 4, 5, or more days, for example. Such style retention can be in conditions of dry air (e.g., relative humidity≤50%) or humid air (e.g., relative humidity over 50%), for example (typically for a period of time during which the styled hair is not washed or rinsed).

Non-limiting examples of compositions and methods disclosed herein include:
1. A method (process) of producing an ester derivative of an alpha-glucan (alpha-glucan ester derivative), the method comprising: (a) contacting an alpha-glucan in a reaction composition with at least one esterification agent comprising an organic group, wherein the reaction composition comprises a solvent (liquid reaction medium) that comprises (i) water and/or (ii) organic solvent(s), wherein the solvent (liquid reaction medium) has a pH of at least about 9 or 10 (e.g., 9-10), wherein at least about 50% of the glycosidic linkages of the alpha-glucan are alpha-1,6 linkages, wherein at least one organic group is esterified to the alpha-glucan thereby producing an alpha-glucan ester derivative, wherein the alpha-glucan ester derivative has a degree of substitution (DoS) up to about 3.0 with the organic group, and (b) optionally isolating the alpha-glucan ester derivative from at least a portion of the solvent (liquid reaction medium).
2. The method of embodiment 1, wherein the solvent comprises the (i) water and (ii) organic solvent(s).
3. The method of embodiment 1 or 2, wherein a portion of the alpha-glucan is dissolved in the solvent, and another portion of the alpha-glucan is suspended in the solvent (as a solid, forming a slurry; i.e., this portion of the alpha-glucan is insoluble in the solvent).
4. The method of embodiment 1, 2, or 3, wherein step (a) comprises: mixing the alpha-glucan into a preparation comprising (i) water and (ii) organic solvent(s) to provide a slurry (i.e., at least a portion of the alpha-glucan is insoluble in the preparation), and then adjusting the pH of the slurry to at least about 9 or 10 (e.g., 9-10).
5. The method of embodiment 1, 2, 3, or 4, wherein the solvent comprises about 5% to about 65% water by weight.
6. The method of embodiment 1, 2, 3, 4, or 5, wherein the organic solvent comprises toluene, isopropanol, acetone, methyl ethyl ketone, acetonitrile, 1,4-dioxane, 2-butanol, or tetrahydrofuran (e.g., wherein the organic solvent comprises toluene or isopropanol).
7. The method of embodiment 1 or 3, wherein the solvent is (consists of) water.
8. The method of embodiment 1, 2, 3, 4, 5, 6, or 7, wherein the organic group is a hydrophobic organic group.
9. The method of embodiment 8, wherein the hydrophobic organic group comprises a C₂ to C₂₆ acyl group (e.g., a C₆ to C₁₈ acyl group, a C₈ to C₁₆ acyl group, a C₁₀ to C₁₄ acyl group, or a C₁₂ acyl group).
10. The method of embodiment 8 or 9, wherein the hydrophobic organic group comprises an aryl group (e.g., a benzoyl group or a substituted benzoyl group).
11. The method of embodiment 1, 2, 3, 4, 5, 6, 7, 8, 9, or 10, wherein the alpha-glucan comprises at least 1% alpha-1,2 and/or alpha-1,3 branches.
12. The method of embodiment 1, 2, 3, 4, 5, 6, 7, 8, 9, 10, or 11, wherein the alpha-glucan has a weight-average degree of polymerization (DPw) of at least 6.
13. The method of embodiment 1, 2, 3, 4, 5, 6, 7, 8, 9, 10, 11, or 12, wherein the DoS with the organic group is at least about 0.005 (e.g., about 0.005 to about 1.5, or about 0.005 to about 1.0).
14. A composition (product) comprising an alpha-glucan ester derivative as produced by the method of embodiment 1, 2, 3, 4, 5, 6, 7, 8, 9, 10, 11, 12, or 13.
15. The composition of embodiment 14, wherein the composition is a household care product, personal care product, medical product, industrial product, or pharmaceutical product.
16. The composition of embodiment 14 or 15, wherein the composition is an aqueous composition.
17. The composition of embodiment 14, 15, or 16, further comprising at least one surfactant.
18. The composition of embodiment 14, 15, 16, or 17, further comprising at least one enzyme.
19. The composition of embodiment 18, wherein the enzyme is a cellulase, protease, amylase, lipase, or nuclease.
20. The composition of embodiment 14, 15, 16, 17, 18, or 19, further comprising at least one of a complexing agent, soil release polymer, surfactancy-boosting polymer, bleaching agent, bleach activator, bleaching catalyst, fabric conditioner, clay, foam booster, suds suppressor, anti-corrosion agent, soil-suspending agent, anti-soil re-deposition agent, dye, bactericide, tarnish inhibitor, optical brightener, perfume, saturated or unsaturated fatty acid, dye transfer-inhibiting agent, chelating agent, hueing dye, visual signaling ingredient, anti-foam, structurant, thickener, anti-caking agent, starch, sand, or gelling agent.
21. The composition of embodiment 14, 15, 16, 17, 18, 19, or 20, wherein the composition is in the form of, or comprised in, a liquid, gel, powder, hydrocolloid, granule, tablet, bead or pastille, single-compartment sachet, multi-compartment sachet, single-compartment pouch, or multi-compartment pouch.

### EXAMPLES

The present disclosure is further exemplified in the following Examples. It should be understood that these Examples, while indicating certain aspects herein, are given by way of illustration only. From the above discussion and these Examples, one skilled in the art can ascertain the essential characteristics of the disclosed embodiments, and without departing from the spirit and scope thereof, can make various changes and modifications to adapt the disclosed embodiments to various uses and conditions.

### Materials/Methods

Representative Preparation of Alpha-1,6-Glucan with Alpha-1,2 Branching

Each alpha-1,2-branched alpha-1,6-glucan listed below comprises a 100%-alpha-1,6-linked backbone upon which pendant (single) glucosyls have been linked via alpha-1,2 linkages; thus, each pendant glucosyl is attached to the backbone via an alpha-1,2 linkage/branch-point. An example of an alpha-1,2-branched alpha-1,6-glucan herein has 40% alpha-1,2-branching and 60% alpha-1,6 linkages. In this example, 60% of all the linkages of the alpha-glucan are alpha-1,6 linkages that are in the backbone, while the balance of the linkages (40%) are alpha-1,2 linkages to pendant glucosyls along the backbone.

Methods to prepare alpha-1,6-glucan containing various amounts of alpha-1,2 branching are disclosed in U.S. Appl. Publ. No. 2018/0282385, which is incorporated herein by reference. Reaction parameters such as sucrose concentration, temperature, and pH can be adjusted to provide alpha-1,6-glucan having various levels of alpha-1,2-branching and molecular weight. A representative procedure for the preparation of alpha-1,2-branched alpha-1,6-glucan is provided below (containing 19% alpha-1,2-branching [i.e., 19% alpha-1,2 linkages] and 81% alpha-1,6 linkages). The 1D ¹H-NMR spectrum was used to quantify glycosidic linkage distribution. Additional samples of alpha-1,6-glucan with alpha-1,2-branching were prepared similarly. For example, one sample contained 32% alpha-1,2-branching and 68% alpha-1,6 linkages, and another contained 10% alpha-1,2-branching and 90% alpha-1,6 linkages.

Soluble alpha-1,6-glucan with about 19% alpha-1,2 branching was prepared using stepwise combination of glucosyltransferase (dextransucrase) GTF8117 and alpha-1,2 branching enzyme GTFJ18T1, according to the following procedure. A reaction mixture (2 L) comprised of sucrose (450 g/L), GTF8117 (9.4 U/mL), and 50 mM sodium acetate was adjusted to pH 5.5 and stirred at 47° C. Aliquots (0.2-1 mL) were withdrawn at predetermined times and quenched by heating at 90° C. for 15 minutes. The resulting heat-treated aliquots were passed through a 0.45-μm filter. The flow-through was analyzed by HPLC to determine the concentration of sucrose, glucose, fructose, leucrose, oligosaccharides and polysaccharides. After 23.5 hours, the reaction mixture was heated to 90° C. for 30 minutes. An aliquot of the heat-treated reaction mixture was passed through a 0.45-μm filter and the flow-through was analyzed for soluble mono/disaccharides, oligosaccharides, and polysaccharides. A major product was linear dextran (i.e., 100% alpha-1,6 linkages) with a DPw of 93.

A second reaction mixture was prepared by adding 238.2 g of sucrose and 210 mL of alpha-1,2-branching enzyme GTFJ18T1 (5.0 U/mL) to the leftover heat-treated reaction mixture that was obtained from the GTF8117 reaction described immediately above. The mixture was stirred at 30° C. with a volume of ~2.2 L. Aliquots (0.2-1 mL) were withdrawn at predetermined times and quenched by heating at 90° C. for 15 minutes. The resulting heat-treated aliquots were passed through a 0.45-μm filter. The flow-through was analyzed by HPLC to determine the concentration of sucrose, glucose, fructose, leucrose, oligosaccharides and polysaccharides. After 95 hours, the reaction mixture was heated to 90° C. for 30 minutes. An aliquot of the heat-treated reaction mixture was passed through a 0.45-μm filter and the flow-through was analyzed for soluble mono/disaccharides, oligosaccharides, and polysaccharides. Leftover heat-treated mixture was centrifuged using 1-L centrifugation bottles. The supernatant was collected and cleaned more than 200-fold using an ultrafiltration system with 1- or 5-kDa MWCO cassettes and deionized water. The cleaned oligo/polysaccharide product solution was dried. Dry sample was then analyzed by ¹H-NMR spectroscopy to determine the anomeric linkages of the oligosaccharides and polysaccharides.

Various water-soluble alpha-1,2-branched alpha-1,6-glucans can be made following the above (or similar) enzymatic reaction strategy, for example. This type of alpha-glucan material can also be produced according to methodology disclosed in U.S. Pat. Appl. Publ. No. 2018/0282385, for example, which is incorporated herein by reference. Examples of different alpha-1,2-branched alpha-1,6-glucans that have been produced are listed in Table 1. In each of these alpha-glucans, the alpha-1,6-glucan backbone (from which there are alpha-1,2 branches) has 100% alpha-1,6 glycosidic linkages; the listed molecular weight is that of the alpha-1,6-glucan backbone. Each alpha-1,2-branch consists of a single (pendant) glucose unit.

TABLE 1
Alpha-1,2-Branched Alpha-1,6-Glucan

| Backbone | Percent Alpha- |
|---|---|
| MW (kDa) | 1,2 Branching |
| 17 | 40% |
| 17 | 45% |
| 40 | 20% |
| 40 | 40% |
| 60 | 20% |
| 109 | 26% |
| 185 | 5% |
| 185 | 20% |
| 194 | 41% |
| 200 | 10% |
| 200 | 20% |
| 300 | 45% |

### Example 1

### Synthesis and Processing of Alpha-1,2-Branched Alpha-1,6-Glucan Ester Derivatives

This Example demonstrates reactions and processing steps for producing ester-derivatives of alpha-1,2-branched alpha-1,6-glucan. In general, alpha-1,2-branched alpha-1,6-glucan was benzoylated in reactions comprising toluene or isopropanol (IPA) as reaction media, followed by application of different processing regimes to isolate ester products. Any alpha-1,2-branched alpha-1,6-glucan as disclosed herein (e.g., Table 1) can be used as a substrate for these esterification and processing procedures, for example.

### Synthesis in Toluene:

### Producing Benzoyl Alpha-Glucan Ester Samples 194a and 194b

Toluene (1847 g) and DI water (175.1 g) were added to a 3-L thermostated reactor, after which 0.8 mol (129.712 g) of an alpha-1,2-branched alpha-1,6-glucan sample was added under stirring (300 rpm), resulting in a suspension/slurry. The reactor was evacuated and purged with nitrogen, and then 12.8 g of NaOH was added, dissolving almost all of the glucan into a cloudy solution. After 1 hour, 44.98 g of benzoyl chloride was added dropwise within 6 minutes under stirring. The resulting reaction was heated to 70° C. within 40 minutes and the reaction was allowed to continue for 2 hours followed by cooling to 20° C. within 30 minutes. A precipitate formed during and after addition of the benzoyl chloride (forming a slurry). The solids then transferred into a washing beaker with 2 L of ethanol (EtOH) under high shear (ULTRA TURRAX T50 DPX) for 45 seconds at 5000 rpm. The suspension was filtered and washed twice under high shear with 2 L of an ethanol:water mixture (9:1); filtration was used for each intervening washing step. After the final filtration, the wet cake was split into two halves. One half was dried at 55° C. overnight in a cabinet oven and then milled in a lab mill (product 194a). The other half was washed with 2 L of acetone under high shear and dried after filtration at 55° C. overnight and milled in a lab mill (product 194b). Samples of each product were analyzed by ¹H-NMR; the DoS measurements for 194a and 194b were both 0.09.

### Producing Benzoyl Alpha-Glucan Ester Samples 180a and 180b

Products 180a and 180b were produced following the same procedure as above for producing products 194a and 194b, respectively. Samples of each product were analyzed by ¹H-NMR; the DoS measurements for 180a and 180b were 0.24 and 0.13, respectively.

### Producing Benzoyl Alpha-Glucan Ester Samples 185a and 185b (Staged Addition of NaOH)

Toluene (1847 g) and DI water (175.1 g) were added to a 3-L thermostated reactor, after which 0.8 mol (129.712 g) of an alpha-1,2-branched alpha-1,6-glucan sample (as above) was added under stirring (300 rpm), resulting in a suspension/slurry. The reactor was evacuated and purged with nitrogen, and then 51.2 g of NaOH was added, dissolving almost all of the glucan. After 1 hour, 179.92 g of benzoyl chloride was added dropwise within 12 minutes under stirring. The resulting reaction was heated to 70° C. within 60 minutes, after which an additional portion of NaOH (12.8 g) was added. A precipitate formed during and after addition of the benzoyl chloride. The reaction was allowed to continue for 1 hour followed by cooling to 30° C. within 34 minutes. Ethanol (2 L) was then added to the reactor. The solids were then transferred into a washing beaker with 2 L of ethanol under high shear (ULTRA TURRAX T50 DPX) for 45 seconds at 5000 rpm. The suspension was filtered, washed twice under high shear with 2 L of an ethanol:water mixture (9:1), and washed twice with the ethanol/water mixture without high shear; filtration was used for each intervening washing step. After the final filtration, the wet cake was split into two halves. One half was washed again three times with 1 L of ethanol under high shear (product 185a). The other half was washed twice with 1 L of acetone under high shear (product 185b). Samples of each product were analyzed by ¹H-NMR; the DoS measurements for 185a and 185b were 0.12 and 0.10, respectively.

### Producing Benzoyl Alpha-Glucan Ester Samples 202a and 202b (Staged Addition of NaOH)

Toluene (1847 g) and DI water (175.1 g) were added to a 3-L thermostated reactor, after which 0.8 mol (129.712 g) of an alpha-1,2-branched alpha-1,6-glucan sample was added under stirring (300 rpm), resulting in a suspension/slurry. The reactor was evacuated and purged with nitrogen, and then 51.2 g of NaOH was added, dissolving almost all of the glucan. After 1 hour, 179.92 g of benzoyl chloride was added dropwise within 12 minutes under stirring. The resulting reaction was heated to 70° C. within 60 minutes, after which an additional portion of NaOH (12.8 g) was added. A precipitate formed during and after addition of the benzoyl chloride. The reaction was allowed to continue for 1 hour followed by cooling to 30° C. within 34 minutes. Ethanol (1.5 L) was then added to the reactor. The solids were then transferred into a washing beaker with 2 L of an ethanol:water mixture (9:1) under high shear (ULTRA TURRAX T50 DPX) for 45 seconds at 5000 rpm. The suspension was filtered, washed three times under high shear with 2 L of the ethanol/water mixture, and washed twice with the ethanol/water mixture without high shear; filtration was used for each intervening washing step. After the final filtration, the wet cake was split into two halves. One half was washed with 2 L of acetone under high shear, separated by filtration, dried at 55° C. overnight in a cabinet oven, and milled in a lab mill (product 202b). The other half was directly dried and milled in a lab mill (product 202a). Samples of each product were analyzed by ¹H-NMR; the DoS measurements for 202a and 202b were 0.48 and 0.13, respectively.

### Producing Benzoyl Alpha-Glucan Ester Samples 186a and 186b (Reaction at 0° C.)

Toluene (1847 g) and DI water (175.1 g) were added to a 3-L thermostated reactor, after which 0.8 mol (129.712 g) of an alpha-1,2-branched alpha-1,6-glucan sample (as above) was added under stirring (300 rpm) at 0° C., resulting in a suspension/slurry. The reactor was evacuated and purged with nitrogen, and then 38.4 g of NaOH was added, dissolving some of the glucan thus leaving a slurry. After 1 hour, 134.94 g of benzoyl chloride was added dropwise within 10 minutes under stirring. The resulting reaction was held at 0° C. for 110 minutes followed by heating to 20° C. within 15 minutes. Precipitate formed (adding to the slurry) during and after addition of the benzoyl chloride. The solids were then transferred into a washing beaker with 2 L of ethanol under high shear (ULTRA TURRAX T50 DPX) for 45 seconds at 5000 rpm. The suspension was filtered, washed again under high shear with 2 L of ethanol, and then washed twice with an ethanol:water mixture (9:1) without high shear; filtration was used for each intervening washing step. After the final filtration, the wet cake was split into two halves. One half was washed again three times with 1 L of ethanol under high shear (product 186a). The other half was washed twice with 1 L of acetone under high shear (product 186b). The DoS measured for 186a was 0.07 as analyzed by ¹H-NMR.

### Producing Benzoyl Alpha-Glucan Ester Samples 216a and 216b

Toluene (1847 g) and DI water (175.1 g) were added to a 3-L thermostated reactor, after which 0.8 mol (129.712 g) of an alpha-1,2-branched alpha-1,6-glucan sample was added under stirring (300 rpm), resulting in a suspension/slurry. The reactor was evacuated and purged with nitrogen, and then 26.71 g of KOH was added, dissolving some of the glucan into a cloudy solution. After 1 hour, 56.23 g of benzoyl chloride was added dropwise within 9 minutes under stirring. The resulting reaction was heated to 70° C. within 40 minutes and the reaction was allowed to continue for 2 hours followed by cooling to 20° C. within 30 minutes. A precipitate formed during and after addition of the benzoyl chloride (forming a slurry). Ethanol (2 L) was then added to the reactor. The solids were then transferred into a washing beaker with 2 L of ethanol:water (9:1) under high shear (ULTRA TURRAX T50 DPX) for 45 seconds at 5000 rpm. The suspension was filtered and washed twice under high shear with 2 L of an ethanol:water mixture (9:1); filtration was used for each intervening washing step. After the final filtration, the wet cake was split into two halves. One half was dried at 55° C. overnight in a cabinet oven and then milled in a lab mill (product 216a). The other half was washed with 2 L of acetone under high shear and dried after filtration at 55° C. overnight and milled in a lab mill (product 216b). Samples of each product were analyzed by ¹H-NMR; the DoS measurements for 216a and 216b were both 0.09.

### Synthesis in Isopropanol (IPA);

### Producing Benzoyl Alpha-Glucan Ester Sample 177

Isopropanol (1292.45 g) and DI water (730.16 g) were added to a 3-L thermostated reactor, after which 0.8 mol (129.712 g) of an alpha-1,2-branched alpha-1,6-glucan sample (as above) was added under stirring (300 rpm), resulting in a suspension/slurry. The reactor was evacuated and purged with nitrogen, and then 32 g of NaOH was added, dissolving some of the glucan thus leaving a slurry. After 1 hour, 112.45 g of benzoyl chloride was added dropwise within 12 minutes under stirring. The resulting reaction was heated to 70° C. within 40 minutes and allowed to continue for 2 hours, after which the reaction was cooled to 20° C. within 30 minutes. Precipitate formed (adding to the slurry) during and after addition of the benzoyl chloride. Ethanol (2 L) was then added to the reactor. The solids were then transferred into a washing beaker with 2 L of ethanol under high shear (ULTRA TURRAX T50 DPX) for 45 seconds at 5000 rpm. The suspension was filtered and washed twice under high shear with 2 L of an ethanol:water mixture (9:1); filtration was used for each intervening washing step. After the final filtration, the wet cake was dried at 55° C. overnight in a cabinet oven and milled in a lab mill (product 177). A sample of the product was analyzed by ¹H-NMR and its DoS was measured to be 0.15.

### Producing Benzoyl Alpha-Glucan Ester Sample 174

Isopropanol (814.35 g) and DI water (1208.26 g) were added to a 3-L thermostated reactor, after which 0.8 mol (129.712 g) of an alpha-1,2-branched alpha-1,6-glucan sample (as above) was added under stirring (300 rpm), resulting in a suspension/slurry. The reactor was evacuated and purged with nitrogen, and then 25.6 g of NaOH was added, dissolving some of the glucan thus leaving a slurry. After 1 hour, 89.96 g of benzoyl chloride was added dropwise within 14 minutes under stirring. The resulting reaction was heated to 70° C. within 40 minutes and allowed to continue for 2 hours, after which the reaction was cooled to 20° C. within 30 minutes. Precipitate formed (adding to the slurry) during and after addition of the benzoyl chloride. Methanol (MeOH) (2 L) was then added to the reactor. The solids were then transferred into a washing beaker with 2 L of methanol under high shear (ULTRA TURRAX T50 DPX) for 45 seconds at 5000 rpm. The suspension was filtered and washed twice under high shear with 2 L of methanol; filtration was used for each intervening washing step. After the final filtration, the wet cake was dried at 55° C. overnight in a cabinet oven and milled in a lab mill (product 174). A sample of the product was analyzed by ¹H-NMR and its DoS was measured to be 0.06.

### Producing Benzoyl Alpha-Glucan Ester Samples 200a and 200b

Isopropanol (1292.45 g) and DI water (730.16 g) were added to a 3-L thermostated reactor, after which 0.8 mol (129.712 g) of an alpha-1,2-branched alpha-1,6-glucan sample was added under stirring (300 rpm), resulting in a suspension/slurry.

The reactor was evacuated and purged with nitrogen, and then 32 g of NaOH was added, dissolving some of the glucan thus leaving a slurry. After 1 hour, 112.45 g of benzoyl chloride was added dropwise within 12 minutes under stirring. The resulting reaction was heated to 70° C. within 40 minutes and allowed to continue for 2 hours, after which the reaction was cooled to 20° C. within 30 minutes. Precipitate formed (adding to the slurry) during and after addition of the benzoyl chloride. Ethanol (2 L) was then added to the reactor. The solids were then transferred into a washing beaker with 2 L of an ethanol:water mixture (9:1) under high shear (ULTRA TURRAX T50 DPX) for 45 seconds at 5000 rpm. The suspension was filtered and washed twice under high shear with 2 L of an ethanol:water mixture (9:1); filtration was used for each intervening washing step. After the final filtration, the wet cake was split into two halves. One half was washed with 2 L of acetone under high shear, separated by filtration, dried at 55° C. overnight in a cabinet oven, and milled in a lab mill (product 200b). The other half was directly dried and milled in a lab mill (product 200a). Samples of each product were analyzed by ¹H-NMR; the DoS measurements for 200a and 200b were 0.04 and 0.03, respectively.

The solubility of the benzoyl alpha-1,2-branched alpha-1,6-glucan ester products in this Example was tested in various solvents. Each product was added to a particular solvent at room temperature (Table 2) at 1 wt % and mixed. The solubility of each product in the solvents is listed in Table 2. Solubility was scored as being soluble (“+”), poorly soluble (“+/−”, some product dissolved), or insoluble (“−”).

TABLE 2
Benzoyl Alpha-1,2-Branched Alpha-1,6-Glucan Ester Product Solubility in Solvent

| Ester | | Ester. | | IPA:Water | | | | | | | | | | | |
|---|---|---|---|---|---|---|---|---|---|---|---|---|---|---|---|
| Product | DoS* | Med. | Water | 10:90 | 20:80 | 30:70 | 50:50 | 70:30 | 80:20 | IPA | MeOH | EtOH | Ac | Tol | DMSO |
| Und. | − | − | + | + | + | +/− | +/− | − | − | − | − | − | − | − | + |
| Glucan^{a} | | | | | | | | | | | | | | | |
| 174 | 0.06 | IPA | +/− | +/− | + | + | + | +/− | − | − | − | − | − | − | + |
| 177 | 0.116 | IPA | +/− | +/− | + | +/− | +/− | − | − | − | − | − | − | − | + |
| 180a | 0.24 | Tol | +/− | +/− | +/− | +/− | +/− | − | − | − | − | − | − | − | + |
| 180b | 0.13 | Tol | +/− | + | + | + | +/− | +/− | − | − | − | − | − | − | + |
| 186a | 0.07 | Tol | + | +/− | +/− | +/− | − | − | − | − | − | − | − | − | + |
| 186b | ND | Tol | + | +/− | +/− | +/− | − | − | − | − | − | − | − | − | + |
| 194a | 0.09 | Tol | + | + | + | + | +/− | +/− | − | − | − | − | − | − | ND |
| 194b | 0.09 | Tol | + | + | + | + | + | +/− | +/− | − | − | − | − | − | ND |
| 200a | 0.04 | IPA | + | + | + | + | + | +/− | +/− | − | − | − | − | − | ND |
| 200b | 0.03 | IPA | + | + | + | + | + | +/− | +/− | − | − | − | − | − | ND |
| 202a | 0.48 | Tol | +/− | +/− | +/− | +/− | +/− | − | − | − | − | − | − | − | ND |
| 202b | 0.13 | Tol | + | + | + | + | + | +/− | +/− | − | − | − | − | − | ND |
| 216a | 0.09 | Tol | + | + | + | + | + | +/− | − | − | − | − | − | − | ND |
| 216b | 0.09 | Tol | + | + | + | + | + | +/− | − | − | − | − | − | − | ND |

^{a}Underivatized alpha-1,2-branched alpha-1,6-glucan.
*Abbreviations: DoS (degree of substitution of ester product), Ester. Med. (esterification medium in which ester product was produced), IPA (isopropanol), MeOH (methanol), EtOH (ethanol), Ac. (acetone), Tol. (toluene), DMSO (dimethylsulfoxide), ND (not determined).

### Example 2

### Benzoyl Ester Synthesis in Water

This Example demonstrates reactions and processing steps for producing ester-derivatives of alpha-1,2-branched alpha-1,6-glucan using water as the reaction solvent. Any alpha-1,2-branched alpha-1,6-glucan as disclosed herein (e.g., Table 1) can be used as a substrate for the below processes (A-D), for example.

### Process A:

An alpha-1,2-branched alpha-1,6-glucan sample (20 g), NaOH (7 g, 50 wt % aqueous) and water (20 mL) were mixed in a three-neck reaction flask. Sodium cumenesulfonate (sodium 2-isopropylbenzenesulfonate) solution (3 g) was then added. This preparation was cooled to below −5° C., after which benzoyl chloride (25 g) was slowly added. The resulting esterification reaction was stirred vigorously at −5° C. for at least 3 hours and then warmed to room temperature (held overnight) to provide a crude ester product mixture/composition. The ester product was precipitated from the crude product mixture with 250 mL of IPA. The ester product powder was then collected and washed twice with acetone (100 mL/each) to afford 23.4 g of final product (benzoyl alpha-1,2-branched alpha-1,6-glucan ester). The DoS of the benzoyl group on the alpha-glucan ester product was determined by NMR to be 0.37.

### Process B:

An alpha-1,2-branched alpha-1,6-glucan sample (20 g), NaOH (10 g, 50 wt % aqueous) and water (47 mL) were mixed in a three-neck reaction flask. Lubrizol Glucamate™ DOE-120 thickener (5 g) (methyl glucose ether esterified with oleic acid) was then added. This preparation was cooled to −5° C., after which benzoyl chloride (28 g) was slowly added. The resulting esterification reaction was stirred vigorously at −5° C. for at least 3 hours and then warmed to room temperature (held overnight) to provide a crude ester product mixture/composition. The ester product was precipitated from the crude product mixture with 250 mL of IPA. The ester product powder was then collected and washed twice with acetone (100 mL/each) to afford 27.5 g of final product (benzoyl alpha-1,2-branched alpha-1,6-glucan ester). The DoS of the benzoyl group on the alpha-glucan ester product was determined by NMR to be 0.21.

### Process C:

An alpha-1,2-branched alpha-1,6-glucan sample (20 g), NaOH (10 g, 50 wt % aqueous) and water (47 mL) were mixed in a three-neck reaction flask. This preparation was cooled to −5° C., after which benzoyl chloride (28 g) was slowly added. The resulting esterification reaction was stirred vigorously at −5° C. for at least 3 hours and then warmed to room temperature (held overnight) to provide a crude ester product mixture/composition. The ester product was precipitated from the crude product mixture with 250 ml of IPA. The ester product powder was then collected and washed twice with acetone (100 mL/each) to afford 21.3 g of final product (benzoyl alpha-1,2-branched alpha-1,6-glucan ester). The DoS of the benzoyl group on the alpha-glucan ester product was determined by NMR to be 0.14.

### Process D:

An alpha-1,2-branched alpha-1,6-glucan sample (10 g) was dissolved in 15 mL of water in a round-bottom flask equipped with an overhead stirrer. To the stirring glucan solution was added a solution of 1,2-dimethylimidazole (6 g dissolved in 5 mL water) dropwise. This preparation was stirred at room temperature for 30 minutes and then cooled to 4° C. in an ice bath. To the cooled preparation was added 4.3 g of benzoyl chloride dropwise via an addition funnel. This preparation was stirred for 2 hours, and then a solution of 1,2-dimethylimidazole (6 g dissolved in 5 mL water) was added dropwise, followed by addition of 4.3 g of benzoyl chloride. This preparation was stirred for another 2 hours at 4° C. The reaction was precipitated into methanol (200 mL). The solid was collected by filtration, and washed with methanol three times (200 mL, 150 mL, 150 mL). The washed sample was dried and analyzed by ¹H NMR. The DoS of the benzoyl group on the alpha-glucan ester product was determined by NMR to be 0.49.

What is claimed is:

1. A method of producing an ester derivative of an alpha-glucan, said method comprising:
(a) contacting an alpha-glucan in a reaction composition with at least one esterification agent comprising an organic group, wherein the reaction composition comprises a solvent that comprises (i) water and/or (ii) organic solvent, wherein the solvent has a pH of at least about 9.0,
wherein at least about 50% of the glycosidic linkages of the alpha-glucan are alpha-1,6 linkages,
wherein at least one organic group is esterified to the alpha-glucan thereby producing an alpha-glucan ester derivative, wherein the alpha-glucan ester derivative has a degree of substitution (DoS) up to about 3.0 with said organic group, and
(b) optionally isolating the alpha-glucan ester derivative from at least a portion of the solvent.

2. The method of claim 1, wherein the solvent comprises said (i) water and (ii) organic solvent.

3. The method of claim 1, wherein a portion of the alpha-glucan is dissolved in the solvent, and another portion of the alpha-glucan is suspended in the solvent.

4. The method of claim 1, wherein step (a) comprises:
mixing the alpha-glucan into a preparation comprising (i) water and (ii) organic solvent to provide a slurry, and then adjusting the pH of the slurry to at least about 9.0.

5. The method of claim 1, wherein the solvent comprises about 5% to about 65% water by weight.

6. The method of claim 1, wherein the organic solvent comprises toluene, isopropanol, acetone, methyl ethyl ketone, acetonitrile, 1,4-dioxane, 2-butanol, or tetrahydrofuran.

7. The method of claim 1, wherein the solvent is water.

8. The method of claim 1, wherein the organic group is a hydrophobic organic group.

9. The method of claim 8, wherein the hydrophobic organic group comprises a C₂ to C₂₆ acyl group.

10. The method of claim 8, wherein the hydrophobic organic group comprises an aryl group.

11. The method of claim 1, wherein the alpha-glucan comprises at least 1% alpha-1,2 and/or alpha-1,3 branches.

12. The method of claim 1, wherein the alpha-glucan has a weight-average degree of polymerization of at least 6.

13. The method of claim 1, wherein the DoS with the organic group is at least about 0.005.

14. A composition comprising an alpha-glucan ester derivative as produced by the method of claim 1.

15. The composition of claim 14, wherein the composition is a household care product, personal care product, medical product, industrial product, or pharmaceutical product.
